(19) United States
(12) Patent Application Publication
(10) Pub. No.: US 2021/0039986 A1
(43) Pub. Date: Feb. 11, 2021

(54) GLASS SUBSTRATE ADHESION CONTROL

(71) Applicant: Corning Incorporated, Corning, NY (US)

(72) Inventors: Gabriel Pierce Agnello, Corning, NY (US); Tatyana Vyacheslavovna Brown, Elmira, NY (US); He Jing, Corning, NY (US); Nikolay Zhelev Zhelev, Painted Post, NY (US)

(21) Appl. No.: 16/978,039

(22) PCT Filed: Mar. 7, 2019
(86) PCT No.: PCT/US2019/021092

§ 371 Date: Sep. 3, 2020

Related U.S. Application Data
(60) Provisional application No. 62/639,707, filed on Mar. 7, 2018.

(51) Int. Cl. C03C 15/00; C03C 3/085; C03C 3/087; C03C 3/091

(52) U.S. Cl. CPC C03C 15/00; C03C 3/091; C03C 3/087; C03C 3/085

(57) ABSTRACT

Methods of processing or modifying a glass substrate such as a glass sheet are disclosed. A method includes contacting at least one of opposing major surfaces of the glass sheet with a fluid applicator apparatus and a liquid etchant composition including acetic acid, ammonium fluoride, and water, the contacting conducted at a predetermined transfer rate of the liquid etchant to the at least one of the opposing major surfaces. The predetermined liquid transfer rate is controlled to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range.

### CROSS REFERENCE TO RELATED APPLICATIONS

This application claims the benefit of priority under 35 U.S.C. § 119 of U.S. Provisional Application Ser. No. 62/639,707 filed on Mar. 7, 2018, the content of which is incorporated herein by reference in its entirety.

### FIELD

The present disclosure relates to control of adhesion between a glass substrates having planar surface and another article having a planar surface, and more particularly, to methods of controlling adhesion of flat glass substrates to planar surfaces.

### BACKGROUND

Flat surfaces in intimate contact with one another often adhere due to several types of material interactions. Depending on the material system involved as well as geometric and/or configurational factors, the force required to separate the two surfaces can vary from miniscule to very significant. This can pose significant challenges in flat panel display manufacturing processes, where dimensionally-large, highly flat and thin glass substrates routinely come into contact with equally large, flat surfaces, such as metal surfaces, which typically serve as vacuum chucks or susceptors in vacuum processing equipment such as chemical vapor deposition chambers and physical vapor deposition chambers.

For example, flat panel display glass used to build a display panel, and particularly that portion of the display panel including thin film transistors, consists of two sides, a functional side (“backplane”) upon which thin film transistors (TFTs) may be built (A-side) and a non-functional B-side. During processing, the B-side glass contacts a variety of materials (i.e. paper, metals, plastics, rubbers, ceramics, etc.,) and can accumulate an electrostatic charge through triboelectrification. For example, when the glass substrate is introduced into the production line and an interleaving material is peeled from the glass substrate, the glass substrate can accumulate an electrostatic charge. Moreover, during the manufacturing process for semiconductor deposition, the glass substrate is commonly placed on a chucking table where the deposition is performed, with the B-side in contact with the chucking table. The chucking table may, for example, restrain the glass via one or more vacuum ports in the chucking table during processing. When the glass substrate is removed from the chucking table, the B-side of the glass substrate can be electrostatically charged through triboelectrification and/or contact electrification. Such electrostatic charge can cause many problems. For example, the glass substrate can be adhered to the chucking table by the electrostatic charge. The term “stiction” is used herein to refer to the normal force that needs to be overcome to separate these two surfaces when they are in a state of static contact, and “stiction force” and “adhesion force” will be used herein interchangeably. Two exemplary environments where stiction may become an issue are in large scale in a plasma enhanced chemical vapor deposition (PECVD) chamber with a susceptor, typically made of a ceramic material, or in photolithography process equipment that uses metal vacuum chucks. In certain circumstances, separation of these flat surfaces from each other can require forces in excess of the glass strength, resulting in breaking of the glass substrate.

In addition to breakage issues, adhesion of flat glass substrates used in display applications can result in device yield loss due to thin film transistor (TFT) pattern misalignment (i.e. excessive total pitch variability, which refers to the variation in alignment of features (such as registry marks)) resulting from uneven mating/adhesion between the glass panel and chucking surface in photolithographic processes. As glass sheets become thinner and metal line width/spacing on glass sheets used for TFTs gets tighter, extremely precise alignment during these types of processes is very important. Uneven surface mating can be the most significant bottleneck for successful patterning processes. In view of these challenges, an appropriate glass surface treatment that could effectively provide a desired and/or controllable adhesion response to a given contact condition would be highly desirable. Depending on the specific application and processing conditions, an anti-sticking glass surface or an adhesion-promoting glass surface (or combination of both) may be desired. Therefore, it would be desirable to provide ways to controllably and predictable tune the adhesion properties of flat glass substrates.

### SUMMARY

In accordance with one or more embodiments disclosed herein, a method of processing a glass sheet comprising opposing major surfaces, the method comprising contacting at least one of the opposing major surfaces of the glass sheet with a fluid applicator apparatus and a liquid etchant composition comprising acetic acid, ammonium fluoride, and water, the contacting conducted at a predetermined transfer rate of the liquid etchant to the at least one of the opposing major surfaces. The method further comprises controlling the predetermined liquid transfer rate to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range.

In one or more embodiments, a method of modifying a glass sheet comprising opposing major surfaces is provided. The method comprises filling a reservoir of a container with a liquid etchant having an adjustable liquid etchant depth, the liquid etchant comprising an amount of acetic acid, and amount of ammonium fluoride and an amount of water and contacting a portion of an outer periphery of a roller with the liquid at a contact angle and a roller submerged depth Dₛ, the roller rotatably positioned relative to the container to rotate at a rotation rate wherein rotating the roller moves the liquid etchant from the reservoir to contact at least one of the opposing major surfaces of the glass sheet. The method of modifying further comprises controllably varying at least one of the rotation rate, the contact angle and the roller submerged depth Dₛ to adjustably texture the at least one of the opposing major surfaces, wherein when the textured major surface and a planar surface are placed in contact, there is an adhesion force between the textured major surface and the planar surface, and wherein the adhesion force is within a target adhesion force range.

It is to be understood that both the foregoing general description and the following detailed description present embodiments of the present disclosure, and are intended to provide an overview or framework for understanding the nature and character of the embodiments as they are claimed. The accompanying drawings are included to provide a further understanding of the embodiments, and are incorporated into and constitute a part of this specification. The drawings illustrate various embodiments of the present disclosure and together with the description serve to explain the principles and operations of the embodiments.

### BRIEF DESCRIPTION OF THE DRAWINGS

FIG. 1 illustrates a schematic view of a fluid applicator apparatus in accordance with embodiments of the disclosure;

FIG. 2 is a schematic cross-sectional view of the fluid applicator apparatus along line 2-2 of FIG. 1 with an adjustable dam at an extended orientation to provide the free surface at an upper elevation;

FIG. 3 illustrates an enlarged view of the fluid applicator apparatus at view 3 of FIG. 1 with the free surface of the liquid at the upper elevation;

FIG. 4 illustrates a schematic cross-sectional view of the fluid applicator apparatus similar to FIG. 2 but showing the adjustable dam at a retracted orientation to provide the free surface at the lower elevation;

FIG. 5 illustrates an enlarged view of the fluid applicator apparatus similar to FIG. 4 but showing the free surface of the liquid at the lower elevation;

FIGS. 6-11 illustrate an embodiment of a method of processing a substrate as the substrate is traversed over a series of rollers;

FIG. 12 is a schematic perspective view of an example adhesion force measurement apparatus according to embodiments disclosed herein;

FIG. 13 is a side cutaway view of the apparatus of FIG. 12;

FIG. 14A is a bottom perspective view of a planar surface of a substrate contacting component of the apparatus of FIG. 12, wherein a plurality of parallel channels are indented into the planar surface;

FIG. 14B is a bottom perspective view of an alternate planar surface of a substrate contacting component, wherein a channel indented into the planar surface includes a section that is perpendicular to at least one other section of the channel;

FIGS. 15A to 15C are side perspective views of a substrate contacting component and a substrate moving relative to each other between first, second, and third, positions;

FIG. 16 is a chart showing total load as a function of time as an adhesion force measurement apparatus and a substrate are moved relative to each other between, first, second, and third positions;

FIG. 17 is a chart showing an exploded view of total load as a function of time as an adhesion force measurement apparatus and a substrate are moved relative to each other between first and second positions;

FIG. 18 is a chart showing an exploded view of total load as a function of time as an adhesion force measurement apparatus and a substrate are moved relative to each other between second and third positions;

FIG. 19 is a graph showing stiction force on the left Y-axis versus dipping level and stiction improvement % on the right Y-axis for Comparative Example 1 and Example 1 samples;

FIG. 20 is a graph showing stiction force on the left Y-axis versus dipping level and stiction improvement % on the right Y-axis for Comparative Example 1A and Example 1 samples;

FIG. 21 is a graph of stiction force plotted against the average roughness in Ra data acquired via atomic force microscope analysis for the samples treated in accordance with Example 1 and Comparative Example 1A;

FIG. 22 is a graph showing stiction force on the left Y-axis versus dipping level and stiction improvement % on the right Y-axis comparing Example 2 substrates and Comparative Example 2 substrates;

FIG. 23 is a graph showing stiction force on the left Y-axis versus dipping level and showing stiction improvement % on the right Y-axis for Examples 3 and 4 compared with Example 3 and 4 substrates with Comparative Examples 3 and 4 substrates; and

FIG. 24 is a graph of stiction force data versus etch time showing stiction improvement of Examples 3 and 4 substrates compared with Comparative Examples 3 (CNTL-inner Y-axis on right and 4 (CNTL-outer Y axis on right) substrates.

### DETAILED DESCRIPTION

Methods of processing a glass substrate, for example, a glass sheet, having opposing major surfaces to obtain an adhesion force between the glass sheet and a planar surface, the adhesion force within a target adhesion force range, are disclosed. In one or more embodiments, a method of processing a glass substrate such as a glass sheet comprises contacting at least one of the opposing major surfaces of the glass sheet with a fluid applicator apparatus and a liquid etchant composition comprising acetic acid, ammonium fluoride, and water, the contacting conducted at a predetermined transfer rate of the liquid etchant to the at least one of the opposing major surfaces. The method further comprises controlling the predetermined liquid transfer rate to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range.

In one or more embodiments, the fluid applicator apparatus can comprise any suitable device that can transmit fluid to the glass substrate. For example, a fluid applicator can comprise selected from the group consisting of one or more of a spray nozzle, a cloth, a sponge, a pad, a roller, and/or a brush. Thus, a fluid applicator could include a spray nozzle and a pad, or a spray nozzle and a roller, or a spray nozzle and a brush. In some embodiments, the fluid applicator can comprise a cloth and a sponge, or a cloth and a pad, or a cloth and a roller or a cloth and a brush. A pad may comprise any suitable type of substance or material for applying fluid to a substrate, for example, a pad may comprise a combination of materials, such as a sponge wrapped with cloth or other fabric. Similarly, a roller may include an outer surface that includes fabric, fibers, filaments, bristles or cloth that contact the substrate during a fluid application operation. In specific embodiments, the fluid applicator apparatus comprises a roller. In some specific embodiments, the roller comprises a porous material (e.g., a sponge), which will be described further below. In some embodiments, the roller comprises a polyurethane compound having an open porous network and a durometer of about 5 shore A. In some embodiments, the fluid applicator apparatus further comprises a container comprising a reservoir having an adjustable liquid etchant depth, the roller having an outer periphery, the roller positioned relative to the container to rotate at a rotation rate, and the outer periphery of the roller contacts the liquid etchant at a contact angle and a roller submerged depth “Dₛ”.

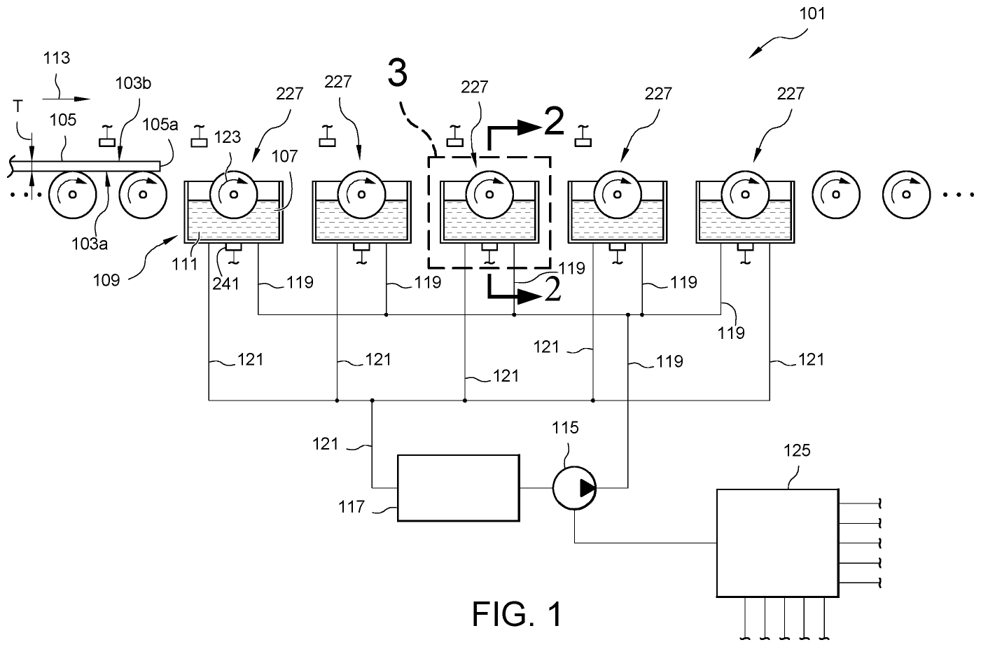

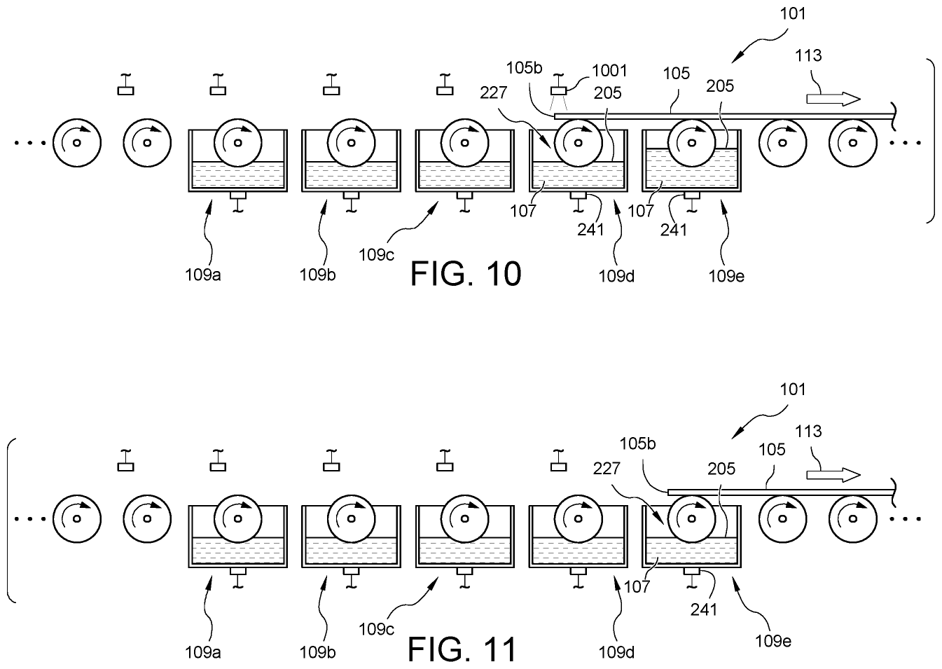

A non-limiting example of a fluid applicator apparatus is shown with respect to FIGS. 1-11 in the form of a fluid applicator apparatus 101. FIG. 1 is a schematic view of a fluid applicator apparatus 101 in accordance with embodiments of the disclosure. The fluid applicator apparatus 101 can contact a first major surface 103a of a substrate 105, which may be in the form of a glass sheet, with liquid 107. As shown, the substrate 105 can further include a second major surface 103b that opposes the first major surface 103a. A thickness “T” of the substrate 105 can be defined between the first major surface 103a and the second major surface 103b. A wide range of thicknesses may be provided depending on the particular application. For example, the thickness “T” can comprise substrates having a thickness of from about 50 micrometers (microns, μm) to about 1 centimeter (cm), such as from about 50 microns to about 1 millimeter (mm), such as from about 50 microns to 500 microns, such as from about 50 microns to 300 microns.

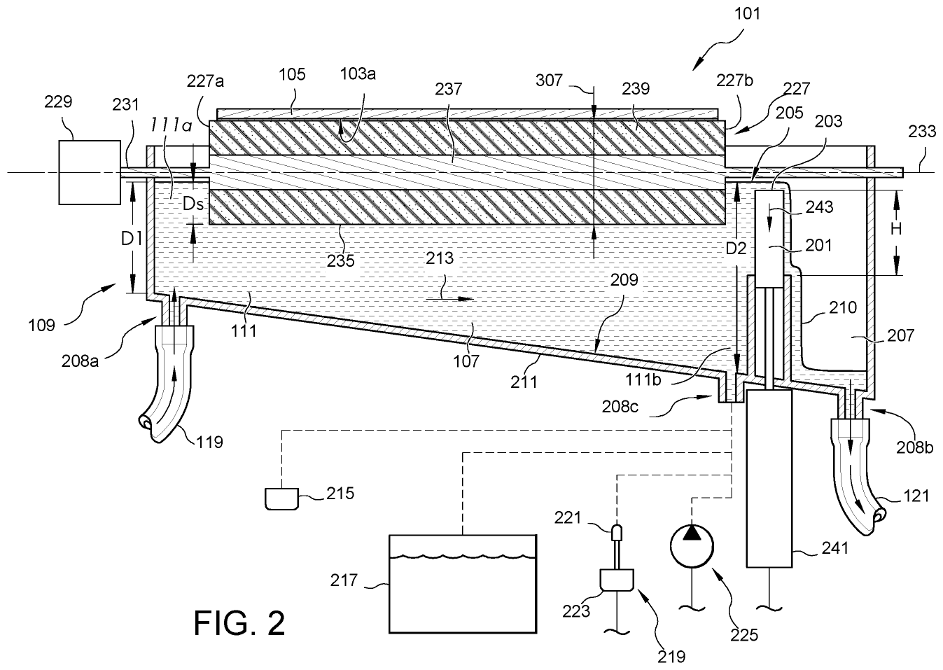

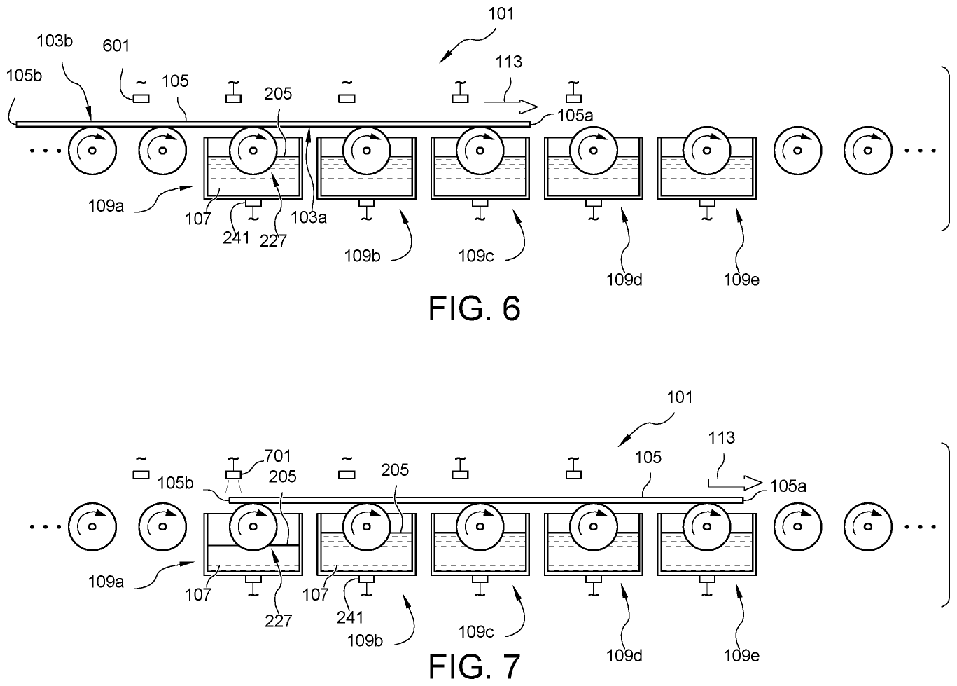

As shown, the thickness “T” of the substrate 105 can be substantially constant along a length of the substrate 105, such as the entire length of the substrate 105 (see FIGS. 6-8). As further shown in FIGS. 2 and 4, the thickness “T” of the substrate 105 can be substantially constant along a width of the substrate 105 that can be perpendicular to the length. As further shown, the thickness “T” of the substrate 105 can be substantially constant along the entire width of the substrate 105. In some embodiments, the thickness “T” can be substantially constant along the entire length and the entire width of the substrate 105. Although not shown, in further embodiments, the thickness “T” of the substrate 105 may vary along a length and/or width of the substrate 105. For instance, thickened edge portions (edge beads) may exist at outer opposed edges of the width that can result from the formation process of some substrates (e.g., glass ribbon). Such edge beads typically include a thickness that may be greater than a thickness of a high quality central portion of the glass ribbon. However, as shown, in FIGS. 2 and 4, such edge beads, if formed with the substrate 105, have already been separated from the substrate 105.

As shown in FIGS. 6-8, the substrate 105 can include a sheet including a leading end 105a and a trailing end 105b wherein the length of the substrate 105 extends between the leading end 105a and the trailing end 105b. In further embodiments, the substrate 105 can comprise a ribbon that can be provided from a source of ribbon. In some embodiments, the source of ribbon can comprise a spool of ribbon that may be uncoiled to be processed or modified by the fluid applicator apparatus 101. For instance, the ribbon can be continuously uncoiled from a spool of ribbon while downstream portions of the ribbon are processed or modified with the fluid applicator apparatus 101. Further, subsequent downstream processes (not shown), may separate the ribbon into sheets or may eventually coil the processed ribbon on a storage spool. In further embodiments, the source of ribbon can comprise a forming device that forms the substrate 105. In such embodiments, the ribbon can be continuously drawn from the forming device and contacted with the fluid applicator apparatus 101 to process the ribbon. Subsequently, in some embodiments the processed ribbon may then be separated into one or more sheets. Alternatively, the processed ribbon may be subsequently coiled on a storage spool.

In some embodiments, the substrate 105 can include silicon (e.g., silicon wafer or silicon sheet), resin, or other materials. In further embodiments, the substrate 105 can include lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. In still further embodiments, the substrate 105 can comprise glass (e.g., aluminosilicate glass, borosilicate glass, soda-lime glass, etc.), glass-ceramic or other materials including glass. In some embodiments, the substrate 105 can include a glass sheet or a glass ribbon, and may be flexible with a thickness “T” of from about 50 microns to about 300 microns, although other ranges of thicknesses and/or nonflexible configurations may be provided in further embodiments. In some embodiments, the substrate 105 (e.g., including glass or other optical material) may be used in various display applications such as liquid crystal displays (LCDs), electrophoretic displays (EPD), organic light emitting diode displays (OLEDs), plasma display panels (PDPs), or other applications.

The fluid applicator apparatus 101 may be used to contact the substrate with various types of liquid 107 on the first major surface 103a of a substrate 105 depending on the desired target adhesion force range. In some embodiments, the liquid comprises a liquid etchant composition designed to texture the first major surface 103a of the substrate 105. The liquid etchant composition can include a material etchant designed to texture the particular material forming the first major surface 103a of the substrate 105. In some embodiments, the etchant can comprise a glass etchant to texture a substrate 105 including glass at the first major surface 103a. In further embodiments, the etchant may comprise an etchant suitable to texture a substrate 105 including silicon at the first major surface 103a.

In some embodiments, the fluid applicator apparatus 101 further includes a container 109 comprising a reservoir 111 wherein liquid 107 may be contained within the reservoir 111 of the container 109. As shown in FIG. 1, the fluid applicator apparatus 101 can include a plurality of containers 109 l (see also 109a-e in FIGS. 6-111) arranged in series along a conveyance direction 113 of the substrate 105. Although a single container 109 may be provided in non-illustrated embodiments, a plurality of containers 109 can increase the response time of changing an elevation of the liquid 107 within the reservoir 111 and can also permit selective processing rates for different portions of the substrate 105 traveling along the conveyance direction 113.

Referring to FIG. 2, the container 109 can further include an adjustable dam 201 including an upper edge 203. As shown, the reservoir 111 can include a first end portion 111a and a second end portion 111b opposed to the first end portion 111a. As shown, the second end portion 111b of the reservoir 111 can be at least partially defined by the adjustable dam 201. Indeed, as shown, the adjustable dam 201 can act as at least a portion of a containment wall 211 of the container 109 wherein an elevation of the free surface 205 of the liquid 107 within the reservoir 111 may be adjusted by adjusting a height “H” (see FIGS. 2 and 4) of the adjustable dam 201. Indeed, the free surface 205 of the liquid 107 can extend over the upper edge 203 of the adjustable dam 201 and can thereafter spill over the adjustable dam 201 into an overflow containment area 207.

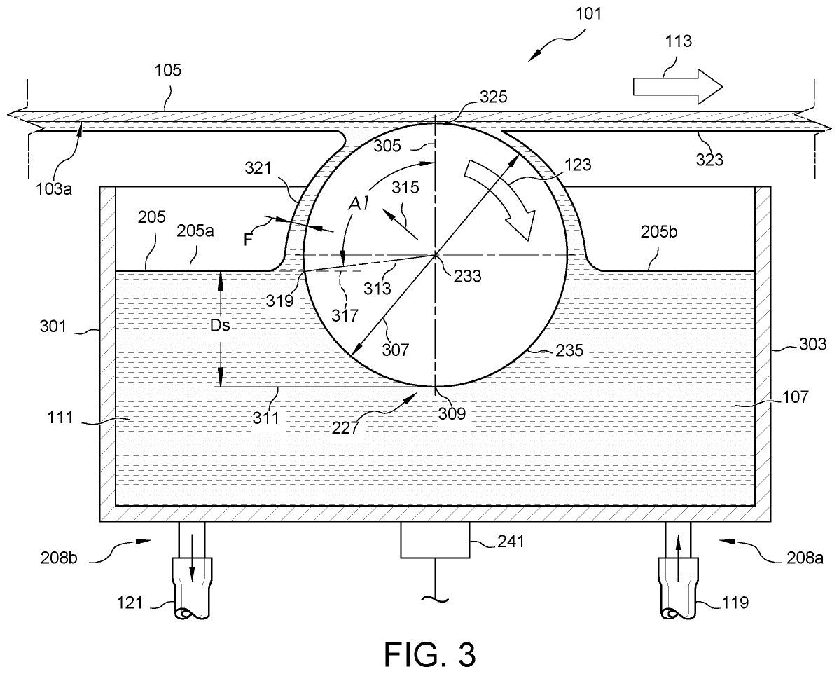

The fluid applicator apparatus 101 can further include an inlet port 208a that opens into the first end portion 111a of the reservoir 111. As shown, the inlet port 208a may provide a liquid inlet path through a containment wall 211 of the container 109. Alternatively, although not shown, the inlet port 208a may comprise a port located above the free surface 205 that pours liquid 107 or otherwise introduces liquid 107 to the reservoir 111. As shown in FIG. 2, a pump 115 may drive liquid 107 from a supply tank 117 through an inlet conduit 119 connected to the inlet port 208a that may be associated with each reservoir 111. In operation, the pump 115 may continuously pump liquid 107 to flow from the inlet conduit 119 into the first end portion 111a of the reservoir 111. As shown in FIG. 2, excess liquid 107 may then flow over the upper edge 203 of the adjustable dam 201 and then spill as an overflow stream of liquid 210. Optionally, the overflow containment area 207 may collect the overflow stream of liquid 210 that can continuously spill over the adjustable dam 201 throughout the process of providing a texture on the first major surface 103a of the substrate 105. Optionally, as shown in FIG. 3, the adjustable dam 201 may be positioned between an outlet port 208b and the inlet port 208a. Indeed, the adjustable dam 201 provides an obstruction to liquid 107 between the inlet port 208a and outlet port 208b. As the adjustable dam 201 may be positioned between the inlet port 208a and the outlet port 208b, only the liquid 107 spilling (e.g., continuously spilling) over the upper edge 203 of the adjustable dam 201 may reach the outlet port 208b from the inlet port 208a.

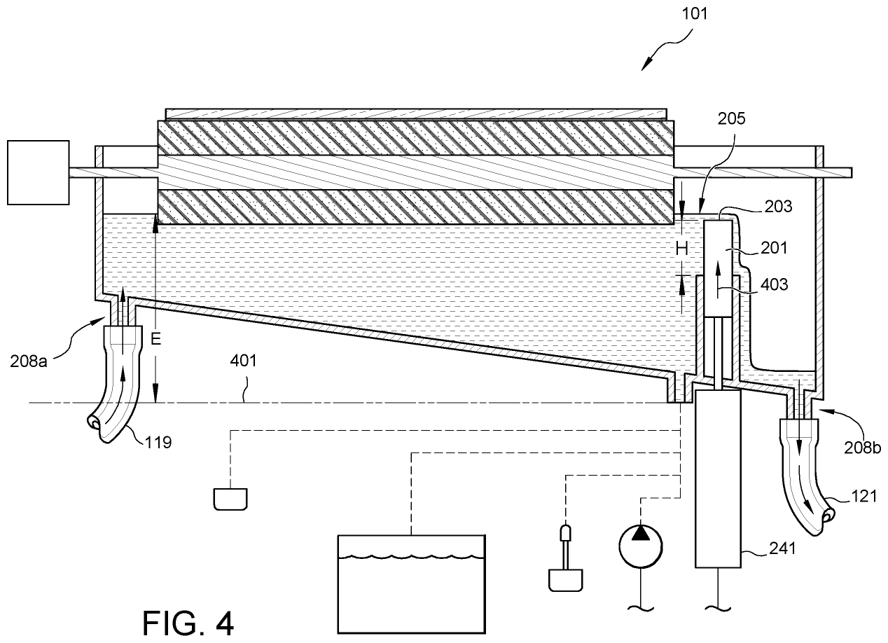

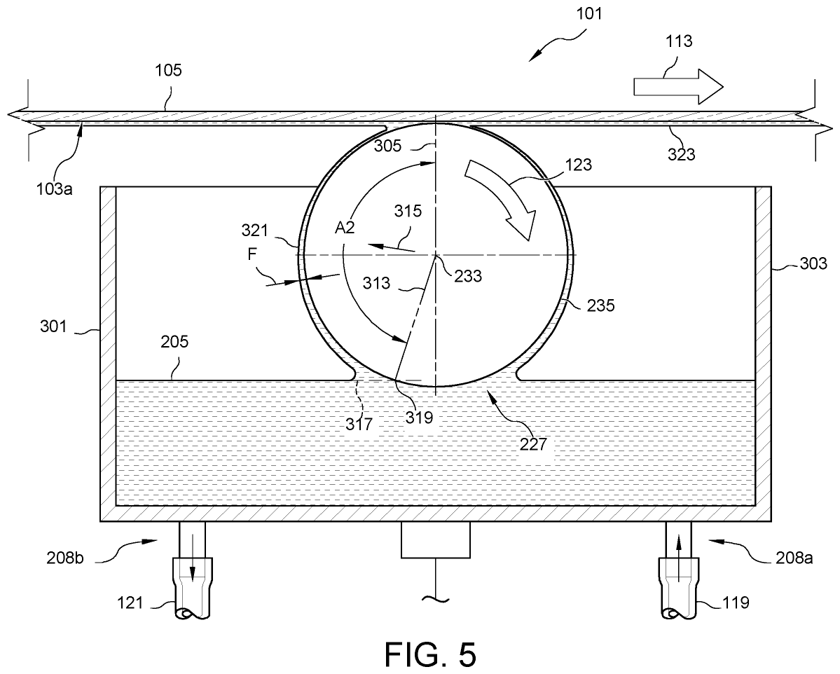

An outlet conduit 121 may be connected to the outlet port 208b that may be associated with each reservoir 111. In operation, liquid may be gravity fed or otherwise returned from the outlet port 208b to the supply tank 117 by way of the outlet conduit 121. As shown in FIG. 2, the outlet port 208b may be positioned downstream from the inlet port 208a such that liquid 107 may flow within the reservoir 111 in direction 213 from the inlet port 208a to the outlet port 208b. FIGS. 3 and 5 schematically illustrate the outlet port 208b positioned closer to a first sidewall 301 than a second sidewall 303 while the inlet port 208a can be positioned closer to the second sidewall 303 than the first sidewall 301. In further embodiments, the inlet port 208a, outlet port 208b and/or outlet port 208c may be positioned along a vertical plane 305 and may optionally pass through a midpoint between the first sidewall 301 and the second sidewall 303.

In some embodiments, the fluid applicator apparatus 101 may include another outlet port 208c that opens into the second end portion 111b of the reservoir 111. As shown, the outlet port 208c may be provided with a liquid path through the containment wall 211 of the container 109. As shown schematically in FIG. 2, the outlet port 208c, if provided, may optionally be provided with a cap 215 designed to plug the outlet port 208c to prevent exiting of liquid 107 from the reservoir 111. Alternatively, the outlet port 208c may be provided with a collection vessel 217 to drain the liquid 107 from the reservoir 111. Indeed, after a sufficient time of use, there may be a desire to flush the system to remove all of the liquid 107 from the container 109. In one embodiment, to flush the system, the cap 215 may be removed from the outlet port 208c and liquid 107 may drain out of the container 109 into the collection vessel 217 for disposal or recycling.

In still further embodiments, a transducer apparatus 219 may be provided with a transducer 221 and a cap 223. The transducer 221 may be inserted into the reservoir 111 and secured in place by a cap 223 that engages the outlet port 208c to prevent draining of the liquid 107 from the reservoir 111. The transducer 221 can emit ultrasonic waves through the liquid 107 to enhance processing of the first major surface 103a of the substrate 105 and/or enhance the functionality achieved with texturing the first major surface 103a of the substrate 105 with the liquid 107 from the reservoir 111.

In further embodiments, a pump 225 may be connected to the outlet port 208c to pulse or otherwise introduce liquid 107 through the outlet port 208c. Introducing liquid 107 (e.g., pulsing liquid 107) through the outlet port 208c can enhance liquid 107 mixing and/or flow characteristics within the reservoir 111.

As the adjustable dam 201 may provide an adjustable elevation, the liquid 107 may be provided with an adjustable depth D1, D2. For purposes of this application, the depth of the liquid 107 is considered defined between a location of a free surface 205 of the liquid 107 and a corresponding location of a lower inner surface 209 of a containment wall 211 of the container 109 at least partially defining a lower extent of the reservoir 111 wherein the corresponding location of the lower inner surface 209 is aligned with the location of the free surface 205 in a direction of gravity. In some embodiments, as shown in FIG. 2, a depth of the liquid 107 corresponding to an adjusted position of the adjustable dam 201 can increase in a direction 213 from the first end portion 111a to the second end portion 111b from a first depth “D1” of the first end portion 111a to a second depth “D2 ” of the second end portion 111b that may be greater than the first depth “D1”. In some embodiments, as shown in FIG. 2, the lower inner surface 209 can be inclined downward in the direction of gravity and in the direction 213. Such downward incline in the direction 213, as shown, can be a continuous incline that may be straight (as shown) or curved. In further embodiments, a stepped or other downwardly inclined configuration in the direction 213 may be provided, however a continuous downward incline in the direction 213 may avoid dead spaces where liquid 107 resides without proper circulation within the reservoir 111. The downward incline in the direction 213 can help promote liquid 107 flow in the direction 213 and can also help promote circulation and mixing of liquid 107 within the reservoir 111 compared to embodiments with an upward incline or no incline.

As further shown in FIG. 2, the fluid applicator apparatus 101 may further include a roller 227 rotatably mounted relative to the container 109. A drive mechanism 229 may be connected to a rotation shaft 231 that extends along a rotation axis 233 of the roller 227. The drive mechanism 229 may apply torque to the rotation shaft 231 to rotate the roller 227 in direction 123 about the rotation axis 233 (see FIG. 3). The drive mechanism 229 may include a drive motor that may be directly connected to the rotation shaft 231 with a coupling or may be indirectly connected to the rotation shaft by a drive belt or drive chain. In some embodiments, a single drive motor may be provided wherein one or more drive belts or drive chains simultaneously rotate the plurality of rollers 227 at the same rotational velocity about each respective rotation axis 233. Alternatively, individual drive motors may be associated with each respective rotation shaft 231 to allow independent rotation of the rollers 227 relative to one another.

As further illustrated in FIG. 2, in some embodiments, the rotation axis 233 of the roller 227 may extend in the direction 213 from the first end portion 111a to the second end portion 111b. As such, the roller can be oriented with the length of the roller 227 between the first end 227a and the second end 227b of the roller oriented in the direction 213 of liquid flow from the first end portion 111a to the second end portion 111b. Such a lengthwise orientation of the roller 227, as shown, can minimize resistance to liquid flow in the direction 213. Furthermore, as shown in FIG. 2, the free surface 205a at the first side of the roller 227 may be maintained at the same or approximately the same elevation as the free surface 205b at the second side of the roller 227. Providing free surfaces 205a, 205b that are maintained at the same or approximately the same elevation can enhance the functionality of the roller in lifting liquid 107 from the reservoir 111 to the first major surface 103a of the substrate 105.

As shown in FIG. 2, an outer periphery 235 of the roller 227 can be defined by a porous material. The porous material can include a closed-cell porous material, although open-cell porous material may readily absorb a quantity of liquid to enhance the liquid transfer rate from the reservoir 111 to the first major surface 103a of the substrate 105. The material defining the outer periphery 235 of the roller 227 can comprise a rigid or flexible material made from polyurethane, polypropylene or other material. Furthermore, in some embodiments, the outer periphery of the roller 227 may be smooth without pores or other surface discontinuities. In further embodiments, the outer periphery of the roller 227 may be patterned with detents, grooves, knurls or other surfaced patterns. In still further embodiments, the outer periphery may include a roller nap of fabric and/or may include protrusions such as fibers, bristles, or filaments.

In some embodiments, the roller 227 may comprise a monolithic cylinder of continuous composition and configuration throughout the entire roller. In further embodiments, as shown, the roller 227 may include an inner core 237 and an outer layer 239 disposed on the inner core 237 that defines the outer periphery 235 of the roller 227. As shown, the inner core 237 can comprise a solid inner core, although a hollow inner core maybe provided in further embodiments. The inner core can facilitate transfer of torque to rotate the roller 227 while the outer layer 239 can be fabricated of material designed to provide desired lifting of liquid 107 from the reservoir and transfer of the liquid on the first major surface 103a of the substrate 105.

With reference to FIG. 3, the diameter 307 of the roller 227 can, for example, be from about 10 mm to about 100 mm, for example from about 10 mm to about 80 mm, or 20 mm to about 50 mm, although rollers with other diameters may be provided in further embodiments. As further illustrated, a portion 309 of the outer periphery 235 of the roller 227 may be disposed within the adjustable depth of the liquid and can extend to a roller submerged depth “Dₛ” below the free surface 205 from 0.5 mm to 50% of the diameter 307 of the roller 227. In some embodiments, the roller submerged depth “Dₛ” can be from about 0.5 mm to about 25 mm, such as from about 0.5 mm to about 10 mm, although other submerged depths may be provided in further embodiments. Roller submerged depth “Dₛ”, for purposes of this application, is considered the depth that the lowest portion of the roller 227 extends below the free surface 205. As shown in FIG. 3, the roller submerged depth “Dₛ” is the distance that a maximum depth plane 311 is offset from the free surface 205 wherein the maximum depth plane 311 is parallel to the free surface 205 and extends tangent to the lowest point of the illustrated circular cylindrical roller 227.

As further illustrated in FIGS. 3 and 5, the roller 227 contacts the liquid 107 at a wide range of contact angles A1, A2. In some embodiments, the contact angle A1, A2 can be from 90° to less than 180° to provide desired liquid transfer rates from the reservoir 111 to the first major surface 103a of the substrate 105. For purposes of this application, the contact angle is considered the angle, facing a direction 315 toward the first major surface 103a of the substrate, between a contact plane 313 and a vertical plane 305 passing through the rotation axis 233 of the roller 227. For purposes of the disclosure, the contact plane 313 is considered the plane intersecting the rotation axis 233 and an intersection line 319 of an extension 317 of the elevation of the free surface 205 and the outer periphery 235 of the roller 227. Indeed, as shown in FIGS. 3 and 5, the extension 317 of the free surface 205 intersects the outer periphery 235 of the roller 227 at the intersection line 319. The contact plane 313 is considered the plane including the intersection line 319 and the rotation axis 233. As shown in FIG. 3, the free surface 205a, 205b can be the same on each side of the roller 227. Thus, the contact angle at each side of the roller 227 can be identical to one another. In further embodiments, two different contact angles may be provided on each side of the roller 227 if the free surfaces 205a, 205b are at different elevations.

Methods of processing or modifying the substrate 105 to adjustably texture at least one of the opposing major surfaces will now be described. A method of processing or modifying the substrate 105 can include filling the reservoir 111 of the container 109 with liquid 107 (e.g., etchant). In some embodiments, filling the reservoir 111 may include introducing the liquid through the inlet port 208a. In further embodiments, the pump 115 may provide liquid from a supply tank 117 to the inlet port 208a by way of the inlet conduit 119. In some embodiments, the reservoir 111 of the container 109 may be continuously filled with liquid 107 while contacting the first major surface 103a of the substrate 105 with the liquid transferred to the first major surface 103a with the roller 227.

Methods of processing or modifying the substrate 105 can also include contacting a portion of the outer periphery 235 of the roller 227 with the liquid 107 at the contact angle A1, A2. In some embodiments, as shown in FIGS. 3 and 5, the contact angle may be from 90° to less than 180° . Methods can also include changing the elevation of the free surface 205 of the liquid 107. For purposes of this application, with reference to FIG. 4, the elevation “E” of the free surface 205 of the liquid 107 is considered relative to a reference elevation 401 that is lower than the elevation of the free surface 205 at any possible adjusted elevation. In embodiments where any adjusted elevation of the free surface 205 is always above sea level, the reference elevation 401 can optionally be considered sea level.

Methods of changing the elevation can be achieved in a wide variety of ways. For instance, changing the elevation “E” of the free surface 205 can include varying a fill rate of an incoming liquid filling the reservoir 111 (e.g., by way of inlet port 208a) and/or varying an exit rate of an outgoing liquid leaving the reservoir (e.g., by way of the adjustable dam 201). In further embodiments, an increased response time with a higher degree of level change of the liquid elevation “E” can be achieved with the adjustable dam 201. Accordingly, any of the embodiments of the disclosure can include adjusting the liquid elevation “E” by adjusting the adjustable dam 201.

The method of changing the liquid elevation “E” with the adjustable dam 201 can include filling the reservoir, such as continuously filling the reservoir, while the free surface 205 of the liquid extends over the upper edge 203 of the adjustable dam 201. The quantity of liquid 210 from the reservoir 111 continuously spills over the upper edge 203 of the adjustable dam 201. To rapidly decrease the elevation of the free surface 205 shown in FIG. 2, an actuator 241 may retract the adjustable dam 201 in downward direction 243 to cause the upper edge 203 to move from the upper position shown in FIG. 2 to the lower position shown in FIG. 4. In response to the relatively quick retraction of the adjustable dam 201, the elevation of the free surface 205 may be quickly lowered to the elevation “E” shown in FIG. 4.

Referring to FIG. 4, if there is a desire to increase the elevation “E” of the free surface 205, the actuator 241 may extend the adjustable dam 201 in the upward direction 403 from the lower position shown in FIG. 4 to the upper position shown in FIG. 2. Consequently, the continuous filling of the liquid 107 into the reservoir (e.g., by way of inlet port 208a) continues filling the reservoir 111, thereby increasing the elevation “E” of the free surface 205 of the liquid 107 until steady state is achieved wherein the liquid continuously spills over the adjustable dam 201 as shown in FIG. 2.

Changing the elevation “E” of the free surface 205 consequently changes the contact angle A1, A2. Indeed, extending the adjustable dam 201 to the upper position shown in FIG. 2 increases the elevation “E” of the free surface 205 to decrease the contact angle to “A1” as shown in FIG. 2. The relatively small contact angle “A1” can provide a relatively high rate of liquid transfer from the reservoir 111 to the first major surface 103a of the substrate 105. On the other hand, retracting the adjustable dam 201 to the lower position shown in FIG. 5 decreases the elevation “E” of the free surface 205 to increase the contact angle to “A2” shown in FIG. 5. The relatively large contact angle “A2” can provide a relatively low rate of liquid transfer from the reservoir 111 to the first major surface 103a of the substrate 105.

The method can further include rotating the roller 227 about the rotation axis 233 to transfer liquid from the reservoir 111 to the first major surface 103a of the substrate 105. As shown in FIG. 3, for example, the roller 227 can rotate in direction 123 to promote translation of the substrate 105 in direction 113 while lifting transferred liquid 321 from the reservoir 111 to contact and thereby texture the first major surface 103a of the substrate 105 with a layer 323 of the transferred liquid 321. In the illustrated embodiment, the first major surface 103a of the substrate 105 may be spaced above the free surface 205 of the liquid 107 and faces the free surface 205. In further embodiments, the roller 227 may not mechanically contact the first major surface 103a of the substrate 105. Rather, as shown in FIG. 3, a portion 325 of the transfer liquid can space the substrate 105 from contacting the roller 227 while transferring the liquid 321 from the reservoir 111 to the first major surface 103a of the substrate 105. Consequently, substrate 105 can be supported on the portions 325 of the transfer liquid on top of each roller 227 as the substrate 105 may be textured and translated along direction 113.

As set forth above, the rate of liquid transfer can be increased by raising the upper edge 203 of the adjustable dam 201 to decrease the contact angle. Indeed, in the extended position shown in FIG. 2, the adjustable dam 201 causes the free surface to rise to the elevation illustrated in FIGS. 2 and 3. With the decreased contact angle “A1” shown in FIG. 3, the film thickness “F” of the layer of transfer liquid 321 being lifted on the outer periphery 235 of the roller 227 may be relatively thick compared to higher contact angles. As such, as shown in FIG. 3, an increased transfer rate of transfer liquid 321 may be achieved from the reservoir 111 to the first major surface 103a of the substrate 105. In such examples, as shown in FIG. 4, a relatively thick layer 323 of transferred liquid 321 may contact the first major surface 103a of the substrate 105.

As further set forth above, the rate of liquid transfer can be decreased by lowering the upper edge 203 of the adjustable dam 201 to increase the contact angle. Indeed, in the retracted position shown in FIG. 4, the adjustable dam 201 causes the free surface to lower to the elevation illustrated in FIGS. 4 and 5. With the increased contact angle “A2” shown in FIG. 4, the film thickness “F” of the layer of transfer liquid 321 being lifted on the outer periphery 235 of the roller 227 may be relatively thin compared to smaller contact angles. As such, as shown in FIG. 5, a decreased transfer rate of transfer liquid 321 may be achieved from the reservoir 111 to the first major surface 103a of the substrate 105. In such examples, as shown in FIG. 5, a relatively thin layer 323 of transferred liquid 321 may contact the first major surface 103a of the substrate 105.

Increasing or decreasing the transfer rate of the transfer liquid can be beneficial to allow selective texturing of different portions of the substrate 105, or providing a different texture on an entire major surface of the substrate to obtain an adhesion force within a target adhesion force range of the glass substrate with a planar surface. For example, FIGS. 6-11 show examples where decreasing the rate of liquid transfer may be conducted in response to the trailing end 105b of the substrate 105 approaching the roller 227. As schematically shown in FIGS. 6-11, the fluid applicator apparatus 101 may include a plurality of sensors 601, 701, 801, 901, 1001 spaced apart from one another along a travel path of the substrate 105 traveling in direction 113. As shown in FIG. 6, the trailing end 105b approaches and may be eventually detected by a first sensor 601. The first sensor 601 can then send a signal through a communication path to a controller 125 (see FIG. 1). In response, the controller 125 can send a signal to the actuator 241 that retracts the adjustable dam 201 of a first container 109a in downward direction 243 from the position shown in FIG. 2 to the retracted position shown in FIG. 4. In response, the elevation “E” of the free surface 205 of the liquid 107 within the first container 109a quickly drops from the elevation shown in FIG. 6 to the elevation shown in FIG. 7. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b passes over the roller 227 associated with the first container 109a. A decrease in the transfer rate of transfer liquid 321 can decrease splatter of liquid that may otherwise undesirably land on the second major surface 103b of the substrate 105 as the trailing end 105b passes over the roller 227 associated with the first container 109a. As such, the roller can provide an increased transfer rate of transfer liquid 321 associated with a relatively small contact angle “A1” to provide adequate contact by the rollers of the first major surface 103a while also providing a relatively large contact angle “A1” to reduce the rate at which transfer liquid 321 is lifted by the roller 227 as the trailing end 105b passes over the roller to avoid undesirable spattering of the liquid to the second major surface 103b of the substrate 105. The change in elevation “E” also changes the roller submerged depth D. As discussed further below, changes to the contact angle, the roller submerged depth Dₛ, and/or the roller rotation rate have an effect on the texture obtained on a major surface of a substrate being processed.

In some embodiments, the controller 125 includes a central processing unit (CPU), a memory, and support circuits (not shown). The controller 125 may control the elevation “E,” which also changes the contact angle and the roller submerged depth Dₛ, as well as the rotation rate of the roller. The controller 125 may control these parameters directly or via computers (or controllers) associated with particular monitoring system and/or support system components. The controller 125 may be one of any form of general-purpose computer processor that can be used in an industrial setting for controlling machine component positioning and rotation rates and sub-processors used in fluid applicator apparatus. The memory, or computer readable medium, of the controller 125 may be one or more of readily available memory such as random access memory (RAM), read only memory (ROM), floppy disk, hard disk, optical storage media (e.g., compact disc or digital video disc), flash drive, or any other form of digital storage, local or remote. The support circuits are coupled to the CPU for supporting the CPU in a conventional manner. These circuits include cache, power supplies, clock circuits, input/output circuitry and subsystems, and the like. One or more processes or lookup tables may be stored in the memory as software routine that may be executed or invoked to control the operation of the fluid applicator apparatus 101. The software routine may also be stored and/or executed by a second CPU (not shown) that is remotely located from the hardware being controlled by the CPU. The controller 125 may be linked via a hard wired connection or wirelessly, for example, using a blue tooth or other suitable wireless connection.

As shown in FIG. 7, the trailing end 105b then approaches and may be eventually detected by a second sensor 701. The second sensor 701 can then send a signal through a communication path to the controller 125. In response, the controller 125 can send a signal to the actuator 241 that retracts the adjustable dam 201 of a second container 109b in downward direction 243 from the position shown in FIG. 2 to the retracted position shown in FIG. 5. In response, the elevation “E” of the free surface 205 of the liquid 107 within the second container 109b quickly drops from the elevation shown in FIG. 7 to the elevation shown in FIG. 7. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b passes over the roller 227 associated with the second container 109b. A decrease in the transfer rate of transfer liquid 321 can decrease splatter of liquid that may undesirably land on the second major surface 103b as the trailing end 105b passes over the roller 227 associated with the second container 109b.

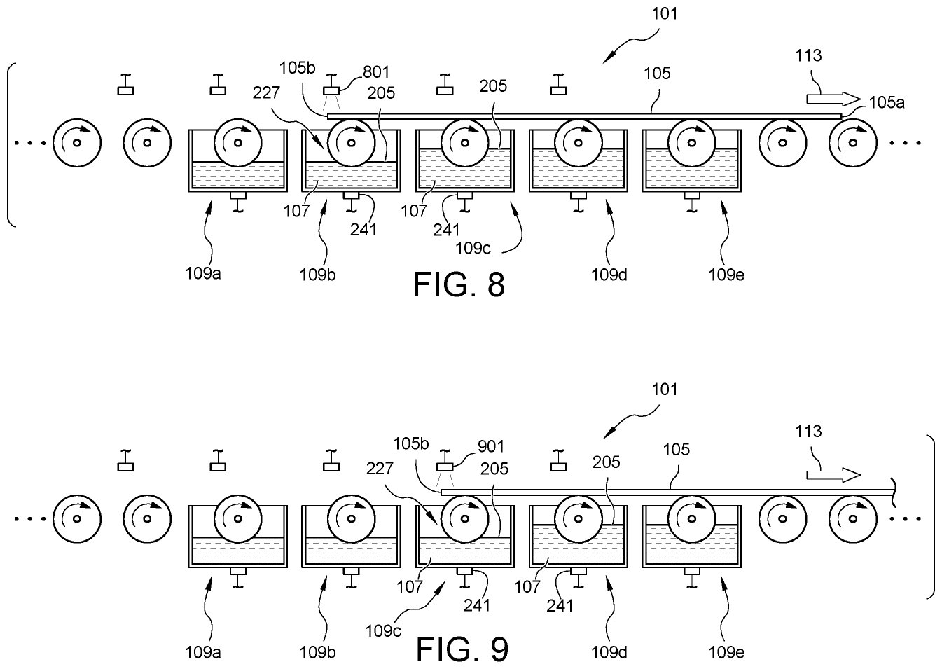

In a similar manner, as demonstrated in FIGS. 8-11, the trailing end 105b then sequentially approaches and may be eventually sequentially detected by sensors 801, 901, 1001. The sensors 801, 901, 1001 can then send corresponding signals through communication paths to the controller 125. In response to each sequential signal, the controller 125 can send sequential signals, respectively, to the actuator 241 associated with each of the third, fourth and fifth containers 109c, 109d, 109e to sequentially retract the adjustable dams 201 of the third, fourth and fifth containers 109c, 109d, 109e. The adjustable dams 201 are then retracted, sequentially, in the downward direction 243 from the position shown in FIG. 3 to the retracted position shown in FIG. 5. In response, the elevation “E” of the free surface 205 of the liquid 107 quickly drops sequentially within the third, fourth and fifth containers. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b of the substrate 105 passes over each sequential roller 227 associated with each sequential container 109c, 109d, 109e. A decrease in the transfer rate of transfer liquid 321 can decrease splatter of liquid that may undesirably land on the second major surface 103b as the trailing end 105b passes over the corresponding roller 227 associated with each of the containers 109c, 109d, 109e.

Although not shown, once the trailing end 105b of the substrate 105 passes over the roller 227, the adjustable dam 201 may again be extended to the position shown in FIG. 5 to raise the elevation of the free surface 205 of the liquid to provide increased liquid transfer rate in preparation for a return of the substrate in a direction opposite direction 113 or in preparation of receiving a new substrate. Indeed, the substrate may be passed back and forth along direction 113 and in a direction opposite direction 113 to achieve the desired texture of the first major surface 103a of the substrate 103. New etchant may be applied during each successive pass to provide additional texturing during each pass (with possible rinsing or other processing intermediate steps) until the desired level of texturing is achieved.

In one or more embodiments, controlling one of the various process parameters that effect the liquid transfer rate as described above with respect to FIGS. 1-11, enables control of the predetermined liquid transfer to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range. In specific embodiments, the fluid applicator apparatus 101 shown with respect to FIGS. 1-11 can comprise the container comprising the reservoir having an adjustable liquid etchant depth, and a roller rotatably positioned relative to the container to rotate at a rotation rate such that the outer periphery of the roller contacts the liquid etchant at a contact angle and a roller submerged depth “Dₛ”. Parameters that effect the liquid transfer rate are controlled and/or adjusted to provide a desired texture on the at least one of the opposing major surfaces to obtain an adhesion force within a target adhesion force range of when the glass sheet is placed in contact with a planar surface. In some embodiments, the outer periphery of the roller comprises a porous material.

In one or more embodiments, the predetermined liquid transfer rate is determined by a selected value of at least one of the contact angle, the roller submerged depth “Dₛ,” and the rotation rate, and the selected value is correlated with the predetermined liquid transfer rate. Thus, according to some embodiments, empirical data can be obtained for a range of individual contact angle values to determine the effect of individual contact angle on the liquid transfer rate. Each of the individual contact angle values is then correlated with individual liquid transfer rate values. Each of the individual liquid transfer rate values is then correlated with a texture obtained on at least one of the opposing major surfaces of the glass sheets. The texture obtained for each individual liquid transfer rate value is then correlated with an adhesion force value of the glass sheet with a planar surface by measuring the adhesion force value of the glass sheet on a planar surface for the texture obtained by each of individual liquid transfer rate values.

The adhesion force value of a glass sheet on a planar surface can be measured as described further below for each of the various textures obtained from the range of individual liquid transfer rate values. Each of the various textures obtained for the range of individual transfer rate values can be correlated with an adhesion force of the glass sheet with a particular planar surface, for example, a metal planar surface that is utilized for a vacuum chuck or a susceptor used in vacuum processing equipment that the glass sheet may be placed upon during a manufacturing operation.

Similarly, empirical data can be obtained for a range of individual roller submerged depth “Dₛ” values to determine the effect of individual roller submerged depth “Dₛ” values on the liquid transfer rate. Each of the individual roller submerged depth “Dₛ” values is then correlated with individual liquid transfer rate values. Each of the individual liquid transfer rate values is then correlated with a texture obtained on at least one of the opposing major surfaces of the glass sheets. The texture obtained for each individual liquid transfer rate values is then correlated with an adhesion force value of the glass sheet with a planar surface by measuring the adhesion force value of the glass sheet on a planar surface for the texture obtained by each of individual liquid transfer rate values.

Likewise, empirical data can be obtained for a range of individual roller rotation rate values to determine the effect of individual roller rotation rate values on the liquid transfer rate. Each of the individual roller rotation rate values is then correlated with individual liquid transfer rate values. Each of the individual liquid transfer rate values is then correlated with a texture obtained on at least one of the opposing major surfaces of the glass sheets. The texture obtained for each individual liquid transfer rate value is then correlated with an adhesion force value of the glass sheet with a planar surface by measuring the adhesion force value of the glass sheet on a planar surface for the texture obtained by each of individual liquid transfer rate values.

Values for the contact angle, the roller submerged depth “Dₛ” and the roller rotation rate, and their empirically determined relationship to liquid transfer rate, texture and adhesion force for glass substrates of various glass compositions with various planar surface materials (e.g., metals, polymers, etc.) can be stored in a lookup table in the memory of the controller 125. During processing or modifying of a glass sheet, the controller can select and/or adjust values for one or more of the contact angle, the roller submerged depth “Dₛ” and the roller rotation rate, and their relationship to liquid transfer rate to adjustably obtain a desired texture and an adhesion force within the target adhesion force range. In addition to the contact angle, the roller submerged depth “Dₛ” and the roller rotation rate, the amount of acetic acid and/or the amount of ammonium fluoride in the liquid etchant composition will have an effect on the adhesion force of the glass sheet when a major surface of the glass sheet contacted with the etchant is placed in contact with a planar surface. Therefore, the composition of the liquid etchant composition can be adjusted to a preselected value to obtain a desired texture and adhesion force within the target adhesion force range of the glass substrate on a planar surface.

In one or more embodiments, a predetermined liquid transfer rate is determined by a selected value of at least one of the contact angle, the roller submerged depth Dₛ, and the rotation rate, the selected value correlated with the predetermined liquid transfer rate.

By varying at least one of the contact angle, the roller submerged depth Dₛ, the rotation rate, the amount of acetic acid and the amount of ammonium fluoride, an adhesion force within a target adhesion force range of the glass sheet with the planar surface can be obtained.

In some embodiments, an adhesion force within the target adhesion force range is obtained by varying the rotation rate or by setting the rotation rate to a predetermined value to obtain an adhesion force within the target adhesion force range. In some embodiments, an adhesion force within the target adhesion force range is obtained by varying the rotation rate or by setting the rotation rate to a predetermined value to obtain an adhesion force within the target adhesion force range. In some embodiments, an adhesion force within the target adhesion force range is obtained by varying the roller submerged depth Dₛ or by setting the roller submerged depth Dₛ to a predetermined value to obtain an adhesion force within the target adhesion force range of the glass sheet with the planar surface. In some embodiments, both the rotation rate and the roller submerged depth Dₛ are varied or set to predetermined values to obtain an adhesion force within the target adhesion force range of the glass sheet with the planar surface.

The amount of the acetic acid in the liquid etchant composition can also be varied. In some embodiments, the acetic acid is present in the liquid etchant composition in an amount of from about 20% to about 70% by weight, from about 30% to about 65% by weight, from about 40% to about 65% by weight or from about 50% to about 60% by weight. In some embodiments, the ammonium fluoride is present in the liquid etchant composition in an amount of from about 5% to about 40% by weight, from about 5% to about 35% by weight, from about 5% to about 30% by weight or from about 10% to about 25% by weight. In some embodiments, water is present in the liquid etchant composition in an amount of from about 10% to about 50% by weight, of from about 15% to about 45% by weight, from about 15% to about 40% by weight or of from about 20% by weight to about 35% by weight. In some embodiments of the method, the glass sheet is a chemically strengthened glass sheet.

In other embodiments, the apparatus of FIGS. 1-11 can be used to practice a method of modifying a glass sheet comprising opposing major surfaces. The method of modify a glass sheet comprises filling a reservoir of a container with a liquid etchant having an adjustable liquid etchant depth, the liquid etchant comprising an amount of acetic acid, and amount of ammonium fluoride and an amount of water; contacting a portion of an outer periphery of a roller with the liquid at a contact angle and a roller submerged depth Dₛ, the roller rotatably positioned relative to the container to rotate at a rotation rate wherein rotating the roller moves the liquid etchant from the reservoir to contact at least one of the opposing major surfaces of the glass sheet; and controllably varying at least one of the rotation rate, the contact angle and the roller submerged depth Dₛ to adjustably texture the at least one of the opposing major surfaces and provide a textured major surface to obtain an adhesion force within target adhesion force range when the glass sheet is placed in contact with a planar surface. The method can be varied of the acetic acid in the liquid etchant composition can also be varied. In some embodiments, the acetic acid is present in the liquid etchant composition in an amount of from about 20% to about 70% by weight, from about 30% to about 65% by weight, from about 40% to about 65% by weight or from about 50% to about 60% by weight. In some embodiments, the ammonium fluoride is present in the liquid etchant composition in an amount of from about 5% to about 40% by weight, from about 5% to about 35% by weight, from about 5% to about 30% by weight or from about 10% to about 25% by weight. In some embodiments, water is present in the liquid etchant composition in an amount of from about 10% to about 50% by weight, of from about 15% to about 45% by weight, from about 15% to about 40% by weight or of from about 20% by weight to about 35% by weight.

In some embodiments in the method of modifying the glass sheet, the roller comprises a porous surface. In some embodiments, the rotation rate, the contact angle and the roller submerged depth Dₛ are controllable by a controller. In some embodiments, the controller controls at least one of the rotation rate, the contact angle and the roller submerged depth Dₛ to a predetermined value to obtain an adhesion force within the target adhesion force range of the glass sheet with a planar surface. In some embodiments, the controller is set to cause an increase to the adhesion force upon completion of the method. In one or more embodiments, the controller is set to cause a decrease to the adhesion force range upon completion of the method.

In some embodiments, the methods described herein can be utilized to manufacture and provide glass substrates having predictable and “tunable” (i.e., adjustable) stiction or adhesion properties to planar surfaces that the glass substrates will come into contact with during manufacturing processes or transport processes. Thus, in some embodiments, a glass substrate can be processed, modified or adjustably textured on a major glass surface to have a relatively high adhesion force within a target adhesion force range that promotes adhesion with a planar surface (or pro-stiction). In other embodiments, a glass substrate can be processed, modified or adjustably textured on a major surface to have a relatively low or zero adhesion force within a target adhesion force range that causes the glass substrate and a planar surface to not adhere or adhere with a minimal amount of adhesion force (or anti-stiction).

The methods described herein can be utilized to form a display glass article, and an aspect of the disclosure pertains to a display glass article made by the methods described herein. Display glass articles comprise an adhesion force within a target adhesion force range when a major surface of the glass article is placed in contact with a planar substrate to allow tunable (i.e., adjustable) and predictable handling and processing of the display glass articles in manufacturing operations. For example, during a packaging operation, a major surface of the glass article may be placed in contact with a polymer planar surface. According to one or more embodiments, glass articles can be provided having tunable and predictable adhesion force within a target adhesion force range when a major surface of the glass article is placed in contact with a polymeric major surface. In other embodiments, a major surface of a glass article may be placed in contact with a metal surface, such as a table or chuck of a vacuum chamber or other processing chamber. According to one or more embodiments, glass articles such as a glass sheet can be provided having tunable and predictable adhesion force within a target adhesion force range when a major surface of the glass article is placed in contact with a metal major surface.

In some embodiments, the method of processing or modifying a glass sheet may include cleaning the glass sheet to remove organic and/or inorganic contamination, and then rinsing sufficiently to remove any residue. The cleaning can occur using a solution, such as an aqueous solution that may include a detergent. In one example, the glass sheet can be initially washed with a KOH solution to remove organic contaminants and dust on the surface. Other washing solutions may be substituted as needed. After cleaning the glass substrate may optionally be rinsed, for example with deionized water.

Glacial acetic acid begins to freeze at temperatures below approximately 17° C. Accordingly, in some embodiments, the temperature of the etchant composition may be in a range from about 18° C. to about 90° C., for example in a range from about 18° C. to about 40° C., in a range from about 18° C. to about 35° C., in a range from about 18° C. to about 30° C., in a range from about 18° C. to about 25° C., or even in a range from about 18° C. to about 22° C. Etchant composition temperatures in the lower ranges, for example, ranges in the 18° C. to 30° C. range, are favored since this can reduce vapor pressure and produces fewer vapor-related defects on the glass.

In addition, the temperature of the glass substrate itself at the time the glass substrate is exposed to the etchant composition can affect texturing results. Accordingly, the glass substrate when exposed to the etchant composition may be at a temperature in a range from about 20° C. to about 60° C., for example in a range from about 20° C. to about 50° C., or in a range from about 30° C. to about 40° C. The optimal temperature will depend on glass composition, environmental conditions and the desired texture (e.g., surface roughness). The etchant composition bath, if used, may in some instances be recirculated to prevent stratifications and depletion.

Contact times with the etchant composition may extend from about 5 seconds to less than about 10 minutes, for example in a range from about 10 seconds to about minutes, in a range from about 10 seconds to about 3 minutes, in a range of from about 10 seconds to 90 seconds, or in a range from about 10 seconds to about 60 seconds, although other contact times as may be needed to achieve the desired surface texture may also be used. Surface texture of the glass substrate after contact with the etchant composition can vary with glass composition. Accordingly, etchant composition recipes optimized for one glass composition may require modification for other glass compositions. Such modification is typically accomplished through experimentation within the etchant constituent ranges disclosed herein.

The glass substrate may comprise any suitable glass that can withstand the processing parameters expressly or inherently disclosed herein, for example an alkali silicate glass, an aluminosilicate glass, or an aluminoborosilicate glass. The glass material may be a silica-based glass, for example code 2318 glass, code 2319 glass, code 2320 glass, Eagle XG® glass, Lotus™, and soda-lime glass, etc., all available from Corning, Inc. Other display-type glasses may also benefit from the processes described herein. Thus, the glass substrate is not limited to the previously described Corning Incorporated glasses. For example, one selection factor for the glass may be whether a subsequent ion exchange process may be performed, in which case it is generally desirable that the glass be an alkali-containing glass.

Display glass substrates can have various compositions and be formed by different processes. Suitable forming processes include, but are not limited to float processes and down draw processes such as slot draw and fusion draw processes. See, for example, U.S. Pat. Nos. 3,338,696 and 3,682,609. In the slot draw and fusion draw processes, the newly-formed glass sheet is oriented in a vertical direction.

The glass substrates may be specifically designed for use in the manufacture of flat panel displays and can exhibit densities less than 2.45 g/cm³ and may, in some embodiments, exhibit a liquidus viscosity (defined as the viscosity of the glass at the liquidus temperature) greater than about 200,000 poise (P), or greater than about 400,000 P, or greater than about 600,000 P, or greater than about 800,000 P. Additionally, suitable glass substrates can exhibit substantially linear coefficients of thermal expansion over the temperature range of 0° to 300° C. of 28-35×10⁻⁷/° C., or of 28-33×10⁻⁷/° C., and strain points higher than about 650° C. As used herein, the term “substantially linear” means the linear regression of data points across the specified range has a coefficient of determination greater than or equal to about 0.9, or greater than or equal to about 0.95, or greater than or equal to about 0.98 or greater than or equal to about 0.99, or greater than or equal to about 0.995. Suitable glass substrates can include those with a melting temperature less than 1700° C.

In embodiments of the described methods, the glass substrate comprises a composition in which the major components of the glass are SiO₂, Al₂O₃, B₂O₃, and at least two alkaline earth oxides. Suitable alkaline earth oxides include, but are not limited to MgO, BaO and CaO. The SiO₂ serves as the basic glass former of the glass and has a concentration greater than or equal to about 64 mole percent in order to provide the glass with a density and chemical durability suitable for a flat panel display glass, e.g., a glass suitable for use in an active matrix liquid crystal display panel (AMLCD), and a liquidus temperature (liquidus viscosity) which allows the glass to be formed by a down draw process (e.g., a fusion process). Suitable glass substrates can have a density less than or equal to about 2.45 grams/cm³, or less than or equal to about 2.41 grams/cm³, a weight loss that is less than or equal to about 0.8 milligrams/cm² when a polished sample is exposed to a 5% HCl solution for 24 hours at 95° C., and a weight loss of less than 1.5 milligrams/cm² when exposed to a solution of 1 volume of 50% by weight HF and 10 volumes 40% by weight NH₄F at 30° C. for 5 minutes.

Suitable glass substrates for use with embodiments of the present disclosure can have an SiO₂ concentration less than or equal to about 71 mole percent to allow batch materials to be melted using conventional, high volume melting techniques, e.g., Joule melting in a refractory melter. In some embodiments, the SiO₂ concentration is in a range from about 66.0 mole percent to about 70.5 mole percent, or in a range from about 66.5 mole percent to about 70.0 mole percent, or in a range from about 67.0 mole percent to about 69.5 mole percent.

Aluminum oxide (Al₂O₃) is another glass former suitable for use with embodiments of the disclosure. Without being bound by any particular theory of operation, it is believed that an Al₂O₃ concentration equal to or greater than about 9.0 mole percent provides a glass with a low liquidus temperature and a corresponding high liquidus viscosity. The use of at least about 9.0 mole percent Al₂O₃ may also improve the strain point and the modulus of the glass. In detailed embodiments, the Al₂O₃ concentration may be in the range from about 9.5 to about 11.5 mole percent.

Boron oxide (B₂O₃) is both a glass former and a flux that aids melting and lowers the melting temperature. To achieve these effects, glass substrates suitable for use with embodiments of the present disclosure can have B₂O₃ concentrations equal to or greater than about 7.0 mole percent. Large amounts of B₂O₃, however, lead to reductions in strain point (approximately 10° C. for each mole percent increase in B₂O₃ above 7.0 mole percent), Young's modulus, and chemical durability.

Suitable glass substrates may have a strain point equal to or greater than about 650° C., equal to or greater than about 655° C., or equal to or greater than about 660° C., a Young's modulus equal to or greater than 10.0×10⁶ psi, and a chemical durability as described above in connection with the discussion of the SiO₂ content of the glass. Without being bound by any particular theory of operation, it is believed a high strain point may help prevent panel distortion due to compaction (shrinkage) during thermal processing subsequent to manufacturing of the glass. Accordingly, it is believed a high Young's modulus may reduce the amount of sag exhibited by large glass sheets during shipping and handling.

In addition to the glass formers (SiO₂, Al₂O₃, and B₂O₃), suitable glass substrates may also include at least two alkaline earth oxides, i.e., at least MgO and CaO, and, optionally, SrO and/or BaO. Without being bound by any particular theory of operation, it is believed that alkaline earth oxides provide the glass with various properties important to melting, fining, forming, and ultimate use. In some embodiments, the MgO concentration is greater than or equal to about 1.0 mole percent. In other embodiments, the MgO concentration may be in a range of about 1.6 mole percent and about 2.4 mole percent.

Without being bound by any particular theory of operation, it is believed that CaO produces low liquidus temperatures (high liquidus viscosities), high strain points and Young's moduli, and coefficients of thermal expansion (CTE's) in the most desired ranges for flat panel applications, specifically, AMLCD applications. It is also believed that CaO contributes favorably to chemical durability, and compared to other alkaline earth oxides, CaO is relatively inexpensive as a batch material. Accordingly, in some embodiments, the CaO concentration is greater than or equal to about 6.0 mole percent. In other embodiments, the CaO concentration in the display glass can be less than or equal to about 11.5 mole percent, or in the range of about 6.5 and about 10.5 mole percent.

In some examples, the glass substrate may comprise SiO₂ in a range from about 60 mol % to about 70 mol %; Al₂O₃ in a range from about 6 mol % to about 14 mol %; B₂O₃ in a range from 0 mol % to about 15 mol %; Li₂O in a range from 0 mol % to about 15 mol %; Na₂O in a range from 0 mol % to about 20 mol %; K₂O in a range from 0 mol % to about 10 mol %; MgO in a range from 0 mol % to about 8 mol %; CaO in a range from 0 mol % to about 10 mol %; ZrO₂ in a range from 0 mol % to about 5 mol %; SnO₂ in a range from 0 mol % to about 1 mol %; CeO₂ in a range from 0 mol % to about 1 mol %; less than 50 ppm As₂O₃; and less than 50 ppm Sb₂O₃; wherein 12 mol % Li₂O+Na₂O+K₂O≤20 mol % and 0 mol %≤MgO+CaO≤10 mol %, and wherein the silicate glass is substantially free of lithium.

Certain glass substrates described herein can be laminated glass. In one aspect, the display glass substrate is produced by fusion drawing a glass skin to at least one exposed surface of a glass core. Generally, the glass skin will possess a strain point equal to or greater than 650° C. In some embodiments, the skin glass composition has a strain point equal to or greater than 670° C., equal to or greater than 690° C., equal to or greater than 710° C., equal to or greater than 730° C., equal to or greater than 750° C., equal to or greater than 770° C., or equal to or greater than 790° C. The strain point of the disclosed compositions can be determined by one of ordinary skill in the art using known techniques. For example, the strain point can be determined using ASTM method C336.

In some embodiments, the glass skin can be applied to an exposed surface of a glass core by a fusion process. An example of a suitable fusion process is disclosed in U.S. Pat. No. 4,214,886, which is incorporated by reference herein in its entirety. The fusion glass substrate forming process can be summarized as follows. At least two glasses of different compositions (e.g., the base or core glass sheet and the skin) are separately melted. Each of the glasses is then delivered through an appropriate delivery system to a respective overflow distributor. The distributors are mounted one above the other so that the glass from each flows over top edge portions of the distributor and down at least one side to form a uniform flow layer of appropriate thickness on one or both sides of the distributor. The molten glass overflowing the lower distributor flows downwardly along the distributor walls and forms an initial glass flow layer adjacent to the converging outer surfaces of the bottom distributer. Likewise, molten glass overflowing from the upper distributor flows downwardly over the upper distributor walls and flows over an outer surface of the initial glass flow layer. The two individual layers of glass from the two distributers are brought together and fused at a draw line formed where the converging surfaces of the lower distributor meet to form a single continuously laminated ribbon of glass. The central glass in a two-glass laminate is called the core glass, whereas the glass positioned on the external surface of the core glass is called the skin glass. A skin glass can be positioned on each surface of the core glass, or there may be only one skin glass layer positioned on a single side of the core glass.

The overflow distributor process provides a fire polished surface to the glass ribbon so formed, and the uniformly distributed thickness of the glass ribbon provided by the controlled distributor(s), and the glass sheets cut therefrom, provides the glass sheets with superior optical quality. The glass sheets used as display glass substrates can have a thickness in the range of 100 micrometers (□m) to about 0.7 □m, but other glass sheets that may benefit from the methods described herein may have a thickness in a range from about 10 μn to about 5 mm. Other processes that can be used in the methods disclosed herein are described in U.S. Pat. Nos. 3,338,696, 3,682,609, 4,102,664, 4,880,453, and U.S. Published Application No. 2005/0001201, which are incorporated by reference herein in their entireties. The fusion manufacturing process offers advantages for the display industry, including glass substrates that are flat with excellent thickness control, with a pristine surface quality and scalability. Glass substrate flatness can be important in the production of panels for liquid crystal display (LCD) televisions as any deviations from flatness can result in visual distortions.

In some embodiments, the glass substrate will possess a strain point equal to or greater than 640° C., a coefficient of thermal expansion in a range from about 31×10⁻⁷/° C. to about 57×10⁻⁷/° C., a weight loss less than 20 mg/cm² after immersion for 24 hours in an aqueous 5% by weight HCl solution at about 95° C., that is nominally free from alkali metal oxides and has a composition, calculated in weight percent on the oxide basis, comprising about 49 to 67% SiO₂, at least about 6% Al₂O₃, SiO₂+Al₂O₃>68%, B₂O₃ in a range from about 0% to about 15%, at least one alkaline earth metal oxide selected from the group consisting of, in the preparations indicated, about 0 to 21% BaO, about 0 to 15% SrO, about 0 to 18% CaO, about 0 to 8% MgO and about 12 to 30% BaO+CaO+SrO+MgO.

It should be understood that the foregoing glass compositions are exemplary, and may other glass compositions may benefit from texturing processes disclosed herein.

Measurement of Adhesion Force (Stiction):

The adhesion force (or stiction) between a major surface of a glass substrate and another planar surface can be measured using the apparatus and methods described in U.S. provisional patent application Ser. No. 62/511,036 filed on May 25, 2017, which is discussed in detail in the Examples. Briefly, the adhesion force is measured by placing the major surface of the glass article and the planar surface in contact and measuring the force to separate the textured major surface and the planar surface a force measurement gauge. The major surface of the glass article may be textured.

### EXAMPLES

### Example 1

An Eagle XG® glass substrate (100 mm²) (available from Corning, Inc.) was processed in an apparatus described with respect to FIGS. 1-11 using a 40 mm diameter roller having a sponge surface of a polyurethane compound having an open porous network and a durometer of about 5 shore A and a liquid etchant composition comprising 60% by weight acetic acid, 10% by weight NH₄F and 30% by weight H₂O at room temperature (e.g., about 25° C.). Etchant composition contact times ranged from 30 to 230 seconds, roller speed was varied in a range from 5 millimeters/second to 150 millimeters/second, and the roller submerged depth Dₛ (referred to as dip level or dipping level in the FIGS.) was varied in a range from 2 millimeters to 10 millimeters.

### Comparative Example 1

An Eagle XG® glass substrate (100mm²) (available from Corning, Inc.) having the same dimensions as the substrate in Example 1 was not processed with an etchant composition.

### Comparative Example 1A

A Lotus™ NXT glass substrate (100 mm²) (available from Corning, Inc.) having the following dimensions was processed in an apparatus described with respect to FIGS. 2-12 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 75 to 80 seconds, roller speed was varied in a range from 80 millimeters/second to 125 millimeters/second, and the roller submerged depth Dₛ (referred to as dip level) was varied in a range from 1 millimeters to 10 millimeters.

### Comparative Example 1B

An Eagle XG® glass substrate (100 mm²) (available from Corning, Inc.) was processed in an apparatus described with respect to FIGS. 2-12 using a 40 mm diameter roller having a sponge surface of a polyurethane compound having an open porous network and a durometer of about 5 shore A and a liquid etchant composition comprising 0.35M NaF:1M H₃PO₄ for 80 seconds at 40° C. Contact times and roller speed are shown in Table 1 below.

### Example 2

A Lotus™ NXT glass substrate (available from Corning, Inc.) having the following dimensions (100 mm²) was processed in an apparatus described with respect to FIGS. 1-11 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 10 to 60 seconds, roller speed was varied in a range from 25 millimeters/second to 150 millimeters/second, and the roller submerged depth Dₛ (referred to as dip level) was varied in a range from 2 millimeters to 10 millimeters.

### Comparative Example 2

A Lotus™ NXT glass substrate (available from Corning, Inc.) having the following dimensions [DIMENSIONS] as Example 2 was not processed with an etchant composition.

### Example 3

An ion-exchanged Gorilla® Glass 3 glass substrate (100 mm²) (available from Corning, Inc.) was processed in an apparatus described with respect to FIGS. 1-11 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 30 to 60 seconds, roller speed was maintained at 125 millimeters/second, and the roller submerged depth Dₛ (referred to as dip level) was maintained at 6 millimeters.

### Comparative Example 3

An ion-exchanged Gorilla® Glass 3 glass substrate (available from Corning, Inc.) having the same dimensions as the substrate in Example 1 was not processed with an etchant composition.

### Example 4

A non-ion-exchanged Gorilla® Glass 3 glass substrate (100 mm²) (available from Corning, Inc.) was processed in an apparatus described with respect to FIGS. 1-11 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 30 to 60 seconds, roller speed was maintained at 125 millimeters/second, and the roller submerged depth Dₛ (referred to as dip level) was maintained at 6 millimeters.

### Comparative Example 4

A non-ion-exchanged Gorilla® Glass 3 glass substrate (100 mm²) (available from Corning, Inc.) having the same dimensions as the substrate in Example 1 was not processed with an etchant composition.

### Example 5

An ion-exchanged Gorilla® Glass 5 glass substrate (100 mm²) (available from Corning, Inc.) having the following dimensions was processed in an apparatus described with respect to FIGS. 1-11 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 30 to 60 seconds, roller speed was maintained at 125 millimeters/second, and the roller submerged depth Dₛ (referred to as dip level) was maintained at 6 millimeters.

### Comparative Example 5

An ion-exchanged Gorilla® Glass 5 glass substrate (100 mm²) (available from Corning, Inc.) having the same dimensions as the substrate in Example 1 was not processed with an etchant composition.

### Example 6

A non-ion-exchanged Gorilla® Glass 5 glass substrate (100 mm²) (available from Corning, Inc.) was processed in an apparatus described with respect to FIGS. 1-11 using a 40 mm diameter roller having a sponge surface of a polyurethane compound having an open porous network and a durometer of about 5 shore A and a liquid etchant composition comprising 0.35M NaF:1M H₃PO₄ at 40° C. Etchant composition contact times ranged from 30 to 60 seconds, roller speed was maintained at 125 millimeters/second, and the roller submerged depth Dₛ (referred to as dip level) was maintained at 6 millimeters.

### Comparative Example 6

An non-ion-exchanged Gorilla® Glass 5 (100 mm²) glass substrate (available from Corning, Inc.) having the same dimensions as the substrate in Example 1 was not processed with an etchant composition.

Adhesion (stiction) Force Measurements

Adhesion (stiction) force was measured as described below. All substrates were measured for adhesion (stiction) force on a stainless steel planar surface.

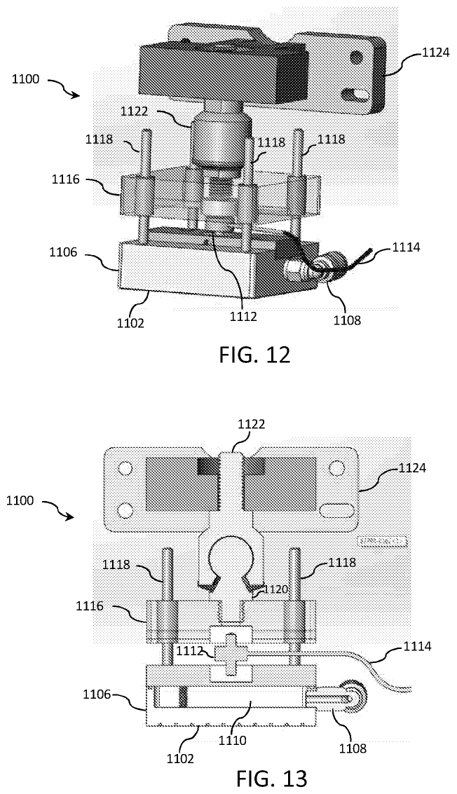

FIG. 12 shows a schematic perspective view of an example adhesion force measurement apparatus 1100 according to embodiments disclosed herein and FIG. 13 shows a side cutaway view of the apparatus 1200 shown in FIG. 12. Apparatus 1100 includes a substrate contacting component 1106 having a planar surface 1102. Substrate contacting component 1106 is rigidly coupled with stabilizing component 1116 via connecting pins 1118. Stabilizing component 1116 is, in turn, coupled with bracket 1124 via threaded engagement members 1120 and 1122.

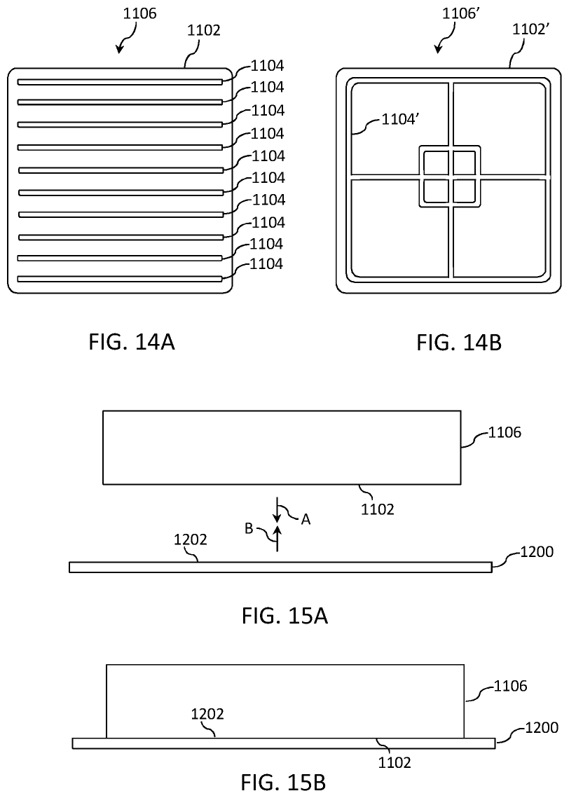

FIG. 14A shows a bottom perspective view the planar surface 1102 of the substrate contacting component 1106 of apparatus 1100 shown in FIGS. 12 and 13. In the embodiment illustrated in FIG. 14A, a plurality of parallel channels 1104 are indented into the planar surface 1102.

FIG. 14B shows a bottom perspective view of an alternate planar surface 1102′ of a substrate contacting component 1106′, wherein a channel 1104′ having a section that is perpendicular to at least one other section of the channel 1104′ is indented into the planar surface 1102′. The channel 1104′ also includes a section that is parallel to at least other section of the channel 1104′. Channel 1104′ can also be characterized as including a larger rectangular section surrounding a smaller rectangular section wherein the rectangular sections are connected by four intersecting connecting sections.

In certain exemplary embodiments, planar surface 1102, 1102′ comprises a metal, such as at least one of aluminum, steel, and brass. Planar surface may also comprise non-metallic materials, such as ceramics or plastics.

In certain exemplary embodiments, planar surface 1102, 1102′ can have an area of from about 5,000 square millimeters to about 500,000 square millimeters.

In certain exemplary embodiments, channels 1104, 1104′ may be formed in the planar surface 1102, 1102′ by one or more methods such as, for example, mechanical cutting (e.g., machining), laser cutting, or molding the planar surface 1102, 1102′ to include the channels 1104, 1104′. The depth of the channels 1104, 1104′, while not limited can range from about 0.5 millimeters to about 1 millimeter. The width of the channels 1104, 1104′, while not limited, can range from about 0.5 millimeters to about 1 millimeter. The length of the channels 1104, 1104′, while not limited, can range from about 10 millimeters to about 120 millimeters.

As shown in FIGS. 12 and 13, apparatus 1100 further includes a vacuum line 1108 and vacuum chamber 1110 that enable channels 1104, 1104′ to be in fluid communication with a vacuum source (not shown). Vacuum source can be operated so as to vary a partial vacuum generated in channels 1104, 1104′ when planar surface 1102, 1102′ contacts an object, such as a substrate, having a planar surface.

Apparatus, 1100 further includes a force measurement gauge 1112 that can be in electrical communication with, for example, a data processing unit (not shown) via lead line 1114. In certain exemplary embodiments, force measurement gauge 1112 can comprise a load cell. The load cell can, for example, be an integrated uni-directional load cell that is calibrated in both tension and compression modes, as known to persons of ordinary skill in the art. Exemplary commercially available load cells include those available from FUTEK Advanced Sensor Technology, Inc., OMEGA Engineering, and Transducer Techniques.

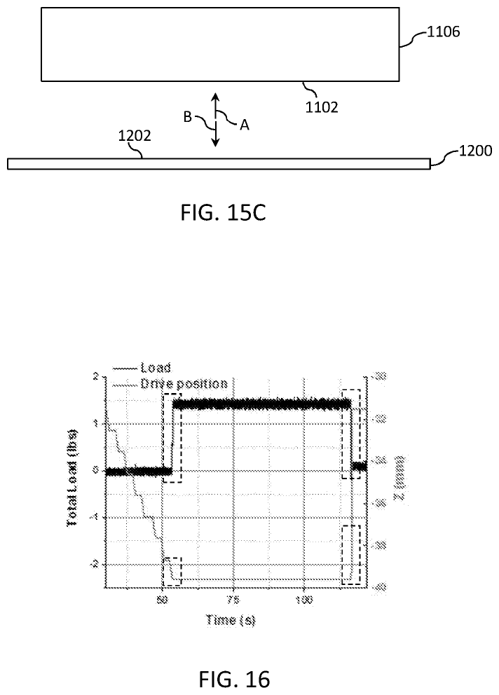

FIGS. 15A-4C show side perspective views of substrate contacting component 1106 of apparatus 1100 and a substrate 1200 moving relative to each other between first, second, and third, positions, respectively. Specifically, FIG. 15A shows a side perspective view of relative movement of substrate contacting component 1106 of apparatus 1100 and substrate 1200 comprising planar surface 1202 from a first position to a second position. As shown in FIG. 15A, planar surface 1102 of substrate contacting component 1106 and planar surface 1202 of substrate 1200 are not in contact with each other but are moving relatively closer to each other, as shown by arrows A and B.

In FIG. 15B, apparatus 1100, including substrate contacting component 1106, and substrate 1200 are shown in a second position, wherein planar surface 1102 of substrate contacting component 1106 and planar surface 1202 of substrate 1200 contact each other. While in this second position, at least a partial vacuum can be generated in at least one channel (e.g., 1104, 1104′ as shown in FIGS. 14A and 14B) through operation of vacuum source through vacuum line 1108 and vacuum chamber 1110.

FIG. 15C shows a side perspective view of relative movement of substrate contacting component 1106 of apparatus 1100 and substrate 1200 comprising planar surface 1202 from a second position to a third position. As shown in FIG. 15C, planar surface 1102 of substrate contacting component 1106 and planar surface 1202 of substrate 1200 are not in contact with each other and are moving relatively farther from each other, as shown by arrows A and B.

As shown in FIGS. 15A-15C surface area of planar surface 1202 of substrate 1200 is shown as being larger than the surface area of planar surface 1102 of substrate contacting component 1106. However, embodiments disclosed herein include those in which planar surface 1202 of substrate 1200 and planar surface 1102 of substrate contacting component 1106 are different relative sizes than are shown in FIGS. 15A-15C, such as where planar surface 1202 of substrate 1200 and planar surface 1102 of substrate contacting component 1106 have approximately the same area or where planar surface 1102 of substrate contacting component 1106 has a larger surface area than planar surface 1202 of substrate 1200. Accordingly, apparatus 1100 can be used to determine adhesion forces of substrates having varying surface areas.

Relative movement between apparatus 1100 and substrate 1200 can occur via movement of one or both of apparatus 1100 and substrate 1200. For example, in certain exemplary embodiments, apparatus 1100 may move toward and away from substrate 1200 while substrate 1200 remains stationary. Alternatively, in certain exemplary embodiments, substrate 1200 may move toward and away from apparatus 1100 while apparatus 1100 remains stationary. In addition, in certain exemplary embodiments, apparatus 1100 and substrate 1200 may both move toward and away from each other.

For example, embodiments disclosed herein include those in which apparatus 1100 is integrated into a larger platform or system, such as, for example, a system that examines additional characteristics of substrates, including, for example, a system that is used to measure electrostatic charge on substrates, as described in U.S. application Ser. No. 62/262,638, the entire disclosure of which is incorporated herein by reference. Such system may be humidity controlled according to methods known by persons having ordinary skill in the art.

In such embodiments, substrate 1200 may be mounted on a mounting platform and optionally secured to the platform using any suitable fastening mechanism, such as clamps, vacuum chucking, and other similar components or methods, or combinations thereof. The mounting platform may, in turn, be included in an assembly platform that can be used to, among other things, position the mounting platform and the apparatus 1100 relative to each other.

For example, in some embodiments, apparatus 1100 may be removably secured via bracket 1124 to a multi-axis actuator, which can be positioned proximate (e.g., above) the mounting platform and actuated to provide three-dimensional motion relative to the mounting platform, such as through the combination of a motor, such as a servo motor, and a positioning sensor. The multi-axis actuator can further include programming for carrying out desired motions or sequences. The motor can be used to power the movement of the multi-axis actuator based on programming selected for a given substrate.

Substrate 1200 can be chosen from, for example, glass substrates, plastic substrates, metal substrates, ceramic substrates, including substrates comprising at least two of glass, plastic, metal, and ceramics. In certain exemplary embodiments, substrate 200 comprises glass, such as a glass sheet or panel. In certain exemplary embodiments, substrate 200 comprises glass, such as a glass sheet or panel that is coated with at least one coating material, such as a at least one coating material selected from inorganic coatings, organic coatings, and polymeric coatings, to name a few.

The thickness of substrate 1200, while not limited, may, for example, range from about 0.05 millimeters to about 5 millimeters. The surface area of substrate 200, while not limited, may, for example, range from about 5,000 square millimeters to about 500,000 square millimeters.

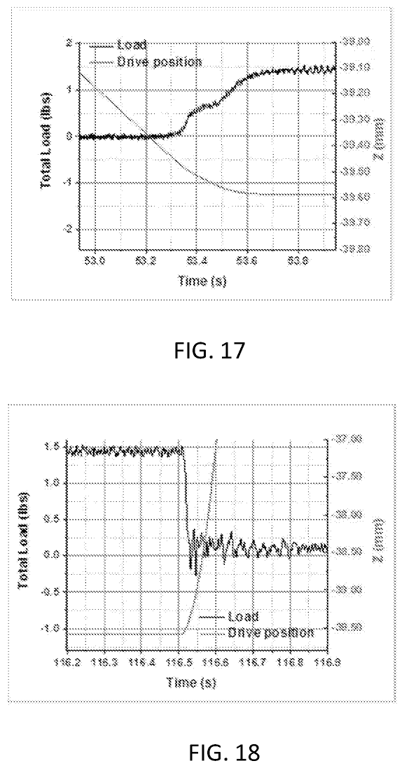

As apparatus 1100 and substrate 1200 are moved relative to each other between first, second, and third positions, the total load or force exerted by apparatus 1100 onto substrate 1200 can be measured by force measurement gauge 1112 and sent to a data processing unit via lead line 114. FIG. 16 is a chart showing total load as a function of time as apparatus 1100 and substrate 1200 are moved relative to each other between, first, second, and third positions, such as is shown in FIGS. 15A-15C. FIG. 17 is a chart showing an exploded view of total load as a function of time as apparatus 1100 and substrate 1200 are moved relative to each other between first and second positions. FIG. 18 is a chart showing an exploded view of total load as a function of time as apparatus 1100 and substrate 1200 are moved relative to each other between second and third positions.

Specifically, FIGS. 16-18 show an average total load as a function of time for five experimental runs. As shown in FIGS. 16-18, apparatus 1100 included substrate contacting component 1106′ including a planar surface 1102′ having channel 1104′ as illustrated in FIG. 14B. Substrate contacting component 1106′ was made of stainless steel and the surface area of substrate contacting component 1106′ was about 10,907 square millimeters, the depth of channel 104′ was about 0.76 millimeters and the width of channel 1104′ was about 0.76 millimeters. Substrate 1200 was made of Eagle XG® glass, available from Corning Incorporated, having a thickness of about 0.5 millimeters and a surface area of about 9,123 square millimeters.

As shown in FIGS. 16-18, apparatus 1100 and substrate 1200 were moved relatively closer to each other until a time of about 53.3 seconds at which point, apparatus 100 and substrate 1200 were in second position, wherein planar surface 1102′ of substrate contacting component 1106′ of apparatus 1100 and planar surface 1202 of substrate 1200 contacted each other. While in the second position, a partial vacuum of about 25 mPa negative pressure was generated in channel 1104′. Upon contact, total load exerted by apparatus 1100 onto substrate 1200 quickly increased from about 0 to about 1.5 pounds.

As shown in FIGS. 16-18, planar surface 1102′ of substrate contacting component 1106′ of apparatus 1100 and planar surface 1202 of substrate 1200 were held in contact for a time of about 63.2 seconds, after which, at a time of about 116.5 seconds, apparatus 1100 and substrate 1200 were moved to a third position, wherein planar surface 1102′ of substrate contacting component 1106′ and planar surface 1202 of substrate 1200 were not in contact.

As shown in FIG. 18, the adhesion force between planar surface 1102′ of substrate contacting component 1106′ and planar surface 1202 of substrate 1200 is represented as a negative load at the moment apparatus 1100 and substrate 1200 began being moved from the second position. In the embodiment of FIG. 18, the adhesion force is about 0.25 pounds. The adhesion force can be broadly summarized as the sum of various forces that result in adherence between surfaces, in this case the adhesion between metal surface of substrate contacting component 1106′ and glass surface of substrate 1200. Such forces can, for example, include electrostatic forces due to non-covalently bonded charge interactions, molecular attractive forces independent of charge state, and capillary forces due to liquid mediated contact or adhesion (such as, for example, resulting from humidity).

In conjunction with apparatus 1100 including a force measurement gauge 1112, apparatus may also include an electrometer that can be in electrical communication with, for example, a data processing unit (not shown) via lead line 1114. The electrometer may, for example, record charge transfer between planar surface 1102, 1102′ of substrate contacting component 1106, 1106′ and substrate 1200 when substrate 1200 is in the second position and as a result of movement between the second position and the third position.

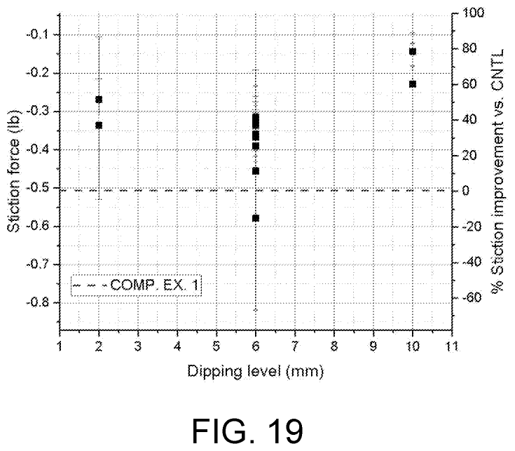

FIG. 19 compares the adhesion (stiction) force of Comparative Example 1 with Example 1. Stiction force in pounds is plotted versus dip level for untreated control (Comparative Example 1) and a treated substrate in accordance with one or more embodiments described herein (Example 1). The right axis expresses stiction force in terms of % stiction improvement relative to control glass substrate. Samples treated under low and high dipping level conditions (corresponding to the sponge barely and completely submerged in the liquid etchant composition bath, respectively) demonstrate anti-sticking performance in the range of about 40-80% relative to control glass Comparative Example 1, with the high dip level condition showing the best response. The mid-dip value of 6 millimeters produced a variable response of about −15-50%, where the negative value indicates adhesion promoting behavior.

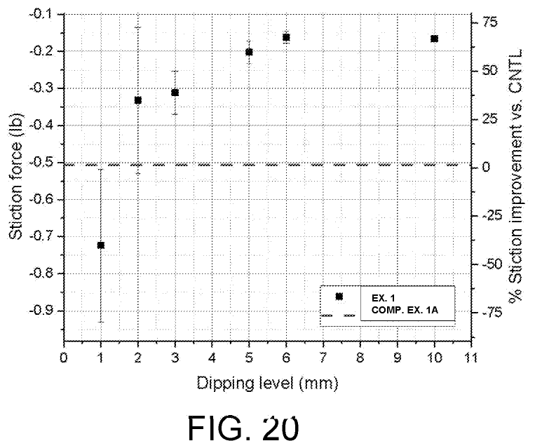

FIG. 20 is a graph comparing HF etchant composition treated samples (Comparative Example 1A) with Example 1 samples. Because the Comparative Example 1A samples were only run under a tight etchant composition contact time window to mimic commercial production conditions, etchant composition contact time was not observed to be a significant factor in this particular experiment. In this experiment, dip level was observed to be a significant driver for stiction force as shown in FIG. 20, where the barely submerged roller demonstrates an adhesion promoting quality flipping towards an anti-stiction behavior as the roller is progressively saturated with solution. In this experiment, roller speed was not observed to be a significant factor.

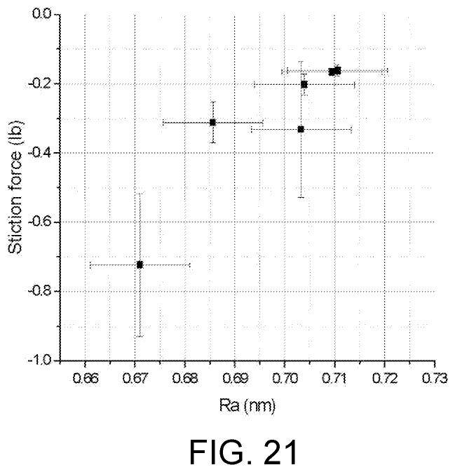

FIG. 21 is a graph of stiction force plotted against the average roughness in Ra data acquired via atomic force microscope analysis for the samples treated in accordance with Example 1 and Comparative Example 1A. As dipping level increased, roughness increased and stiction force decreased, which appeared to be somewhat counterintuitive. The Ra change shown is small, and while the disclosure is not to be limited by a particular principle or theory, it is postulated that that there is a surface chemistry component to the stiction behavior that is impacted by the variable process conditions. The treatment of Comparative Example 1A resulted in a stiction response ranging from about −43% (stiction-promoting) to about −67% (stiction-preventing). The fundamental reasons (e.g., topography mixed with surface chemistry effects) for tunability (i.e., adjustability) of the adhesion force will be studied further in future experiments.

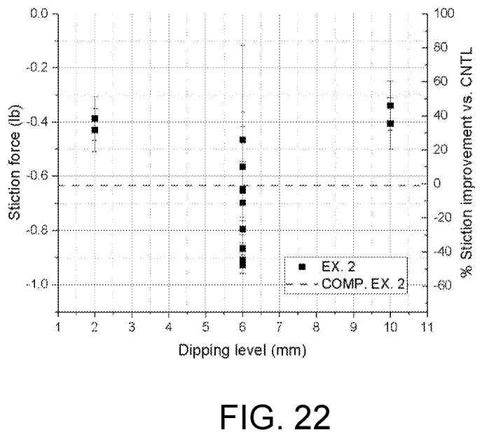

FIG. 22 is a graph showing stiction force on the left Y-axis versus dipping level and stiction improvement % on the right Y-axis comparing Example 2 substrates and Comparative Example 2 substrates. Glass samples treated in accordance with Example 2 resulted in an overall stiction response range of about −46% (stiction-promoting) to about 46% (stiction-preventing).

Further studies will be conducted to gain an understanding of fundamental reasons (e.g., topography mixed with surface chemistry effects) on stiction tunability (i.e., adjustability). Statistical analysis suggested that rotation rate of the roller and contact time with the liquid etchant composition did not significantly effect stiction force for the samples of Example 2. A similar relationship was observed between dipping level and the stiction force as in FIG. 19.

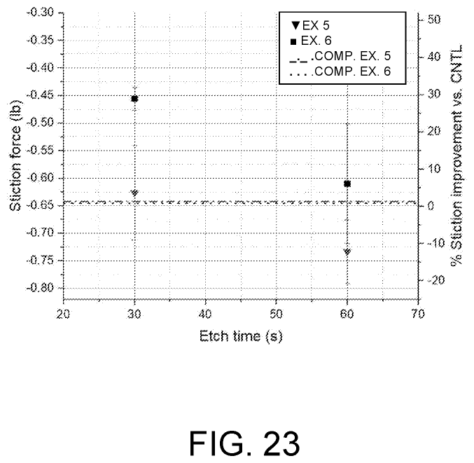

FIG. 23 is a graph showing stiction force on the left Y-axis versus contact time with the etchant composition (etch time) and % stiction improvement for Examples 5 and 6 versus the control sample of Comparative Examples 5 and 6. The data is based on one dip level (6 millimeters) and one roller speed (125 millimeters/s) for two etchant composition contact times (30 seconds and 60 seconds).

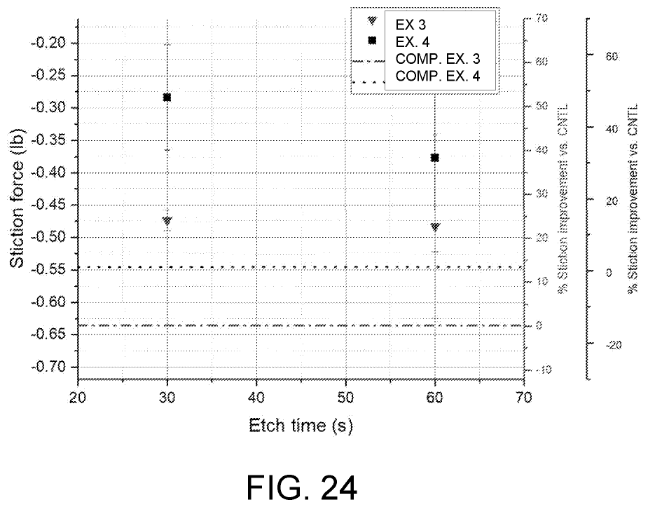

FIG. 24 shows stiction force data versus versus contact time with the etchant composition (etch time) for Examples 3 and 4 versus control data of Comparative Examples 3 (CNTL-inner Y-axis on right and 4 (CNTL-outer Y axis on right). The data suggest an anti-stiction (low adhesion force) effect for 3 of the 4 sample sets. Processing or modification of the Gorilla® Glass substrate samples resulted in an overall stiction response range of about −14% (adhesion (or stiction)-promoting) to about 48% (adhesion (or stiction)-preventing). The fundamental reasons (e.g., topography mixed with surface chemistry effects) for tunability will be further studied.

Table 1 summarizes adhesion (stiction) response of various samples. Samples labeled “Preventer” indicate that the processing resulted in a texture that prevented adhesion or stiction. Samples labeled “Promoter” indicate that the sample had a relative high adhesion force and stuck to a planar surface.

| | | | Roller | Dip level | Stiction | % | |
|---|---|---|---|---|---|---|---|
| | | Contact | speed | range | Force | difference | Treatment |
| Example | Treatment | time (s) | (mm/s) | (mm) | (lb) | from CNTL | Type |
| EX. 1 | INVENTIVE | 90 | 50 | 10 | −0.11 | 78.5 | Preventer |
| | INVENTIVE | 180 | 50 | 6 | −0.58 | −15.1 | Promoter |
| COMP. | HF | 78 | 82 | 6 | −0.16 | 68.1 | Preventer |
| EX. 1 | HF | 75 | 125 | 1 | −0.72 | −42.9 | Promoter |
| EX. 1 | INVENTIVE | 60 | 50 | 10 | −0.34 | 46.5 | Preventer |
| | INVENTIVE | 60 | 50 | 6 | −0.93 | −46.4 | Promoter |
| EX. 3 | INVENTIVE | 30 | 125 | 6 | −0.63 | 2.4 | Preventer |
| | INVENTIVE | 60 | 125 | 6 | −0.73 | −14.6 | Promoter |
| EX. 4 | INVENTIVE | 30 | 125 | 6 | −0.46 | 29.4 | Preventer |
| | INVENTIVE | 60 | 125 | 6 | −0.61 | 5.6 | Preventer |
| EX. 5 | INVENTIVE | 30 | 125 | 6 | −0.47 | 25.5 | Preventer |
| | INVENTIVE | 60 | 125 | 6 | −0.48 | 24.1 | Preventer |
| EX. 7 | INVENTIVE | 30 | 125 | 6 | −0.28 | 48 | Preventer |
| | INVENTIVE | 60 | 125 | 6 | −0.37 | 31 | Preventer |

It will be apparent to those skilled in the art that various modifications and variations can be made to the disclosed embodiments without departing from the spirit and scope of the disclosure. Thus it is intended that the present disclosure cover the modifications and variations of these embodiments provided they come within the scope of the appended claims and their equivalents.

What is claimed is:

1. A method of processing a glass sheet comprising opposing major surfaces, the method comprising:
contacting at least one of the opposing major surfaces of the glass sheet with a fluid applicator apparatus and a liquid etchant composition comprising acetic acid, ammonium fluoride, and water, the contacting conducted at a predetermined transfer rate of the liquid etchant to the at least one of the opposing major surfaces; and
controlling the predetermined liquid transfer rate to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range.

2. The method according to claim 1, wherein the adhesion force is measured by placing the textured major surface and the planar surface in contact and measuring the force to separate the textured major surface and the planar surface a force measurement gauge.

3. The method according to claim 1, wherein the fluid applicator apparatus comprises a roller.

4. The method according to claim 3, wherein fluid applicator apparatus further comprises a container comprising a reservoir having an adjustable liquid etchant depth, the roller having an outer periphery, the roller rotatably positioned relative to the container to rotate at a rotation rate, and the outer periphery of the roller contacts the liquid etchant at a contact angle and a roller submerged depth Dₛ.

5. The method of claim 4, wherein the outer periphery of the roller comprises a porous material.

6. The method of claim 4, wherein the predetermined liquid transfer rate is determined by a selected value of at least one of the contact angle, the roller submerged depth Dₛ, and the rotation rate, the selected value correlated with the predetermined liquid transfer rate.

7. The method of claim 6, further comprising varying at least one of the contact angle, the roller submerged depth Dₛ, the rotation rate, the amount of acetic acid, and the amount of ammonium fluoride to obtain the adhesion force.

8. The method of claim 6, further comprising varying the rotation rate to obtain the adhesion force.

9. The method of claim 6, further comprising varying the roller submerged depth Dₛ to obtain the adhesion force.

10. The method of claim 6, further comprising varying the rotation rate and the roller submerged depth Dₛ to obtain the adhesion force.

11. The method of claim 1, wherein in the liquid etchant, the acetic acid is present in an amount from about 50% to about 60% by weight, the ammonium fluoride is present in an amount of from about 10% to about 25% by weight, and water is present in an amount from about 20% by weight to about 35% by weight, and wherein the glass sheet is a chemically strengthened glass sheet.

12. A method of modifying a glass sheet comprising opposing major surfaces, the method comprising:
filling a reservoir of a container with a liquid etchant having an adjustable liquid etchant depth, the liquid etchant comprising an amount of acetic acid, and amount of ammonium fluoride, and an amount of water;
contacting a portion of an outer periphery of a roller with the liquid etchant composition at a contact angle and a roller submerged depth Dₛ, the roller rotatably positioned relative to the container to rotate at a rotation rate, wherein rotating the roller moves the liquid etchant from the reservoir to contact at least one of the opposing major surfaces of the glass sheet; and
controllably varying at least one of the rotation rate, the contact angle, and the roller submerged depth Dₛ to adjustably texture the at least one of the opposing major surfaces and provide a textured major surface, wherein when the textured major surface and a planar surface are placed in contact, there is an adhesion force between the textured major surface and the planar surface, and wherein the adhesion force is within a target adhesion force range.

13. The method of claim 12, wherein in the liquid etchant, the acetic acid is present in an amount of from about 50% to about 60% by weight, the ammonium fluoride is present in an amount of from about 10% to about 25% by weight, and water is present in an amount of from about 20% by weight to about 35% by weight.

14. The method of claim 12, wherein the roller comprises a porous surface.

15. The method of claim 12, wherein the rotation rate, the contact angle, and the roller submerged depth Dₛ are controllable by a controller.

16. The method of claim 15, wherein the controller controls at least one of the rotation rate, the contact angle, and the roller submerged depth Dₛ to a predetermined value to obtain the adhesion force.

17. The method of claim 16, wherein the controller is set to cause an increase to the adhesion force upon completion of the method.

18. The method of claim 16, wherein the controller is set to cause a decrease to the adhesion force upon completion of the method.

19. The method of claim 16, wherein the glass sheet is a chemically strengthened glass sheet.

20. The method of claim 12, wherein the adhesion force is measured by placing the textured major surface and the planar surface in contact and measuring the force to separate the textured major surface and the planar surface a force measurement gauge.
